(19) United States
(12) Patent Application Publication
(10) Pub. No.: US 2025/0047002 A1
(43) Pub. Date: Feb. 6, 2025

(54) OPTICALLY TRANSPARENT ANTENNA

(71) Applicant: Nano-C, Inc., Westwood, MA (US)

(72) Inventors: Reyhan BAKTUR, Logan, UT (US); Rakib HASAN, Olathe, KS (US)

(21) Appl. No.: 18/365,968

(22) Filed: Aug. 4, 2023

(51) Int. Cl. H01Q 9/06

(52) U.S. Cl. CPC H01Q 9/065

(57) ABSTRACT

Methods, systems, and apparatus for an optically transparent antenna. The optically transparent antenna can include a substrate layer and a conductive layer formed on the substrate layer. In some implementations, the length of the conductive layer is greater than width of the conductive layer. In some implementations, the width of the conductive layer can be at least one eighth the length of the conductive layer. In some implementations, the conductive layer is optically transparent. In some implementation, the optically transparent antenna includes one or more additional conductive layers.

### TECHNICAL FIELD

The present specification relates to transmission and receiving antennas.

### BACKGROUND

Transmission and receiver antennas are used in many applications, such as communications, security and health monitoring, and industrial controls. These antennas are characterized by many factors among which the important ones are the electromagnetic frequency range, impedance, directivity, and electromagnetic polarization.

Optically transparent antennas have gained steady interest in the field of wireless communication due to their optical and electrical advantages and capability of integration with panels, window glass, and screens. A bottle-neck problem faced by any transparent antenna technology is the management of the trade-offs between optical transparency and antenna efficiency such that antennas with greater transparency suffer from poor efficiency, typically below 30%. Therefore, a need exists for an antenna with sufficiently high transparency capable of providing high antenna gains and efficiencies.

### SUMMARY

An optically transparent antenna and antenna array is described herein. In some implementations, the optically transparent antenna is constructed using one or more layers of film. The geometry of the layers is designed to reduce or minimize loss resistance and, thereby, improve the radiation efficiency and gain of the antenna. Each layer of film can have a width less than its length and greater than an eighth of its length. For example, the optically transparent antenna can have two layers of rectangular-shaped film where the width of each of the layers is or approximately is 80% of the length of each of the layers. In some implementations, each layer of film of the optically transparent antenna is made from a conductive material. In some implementations, at least one of the one or more film layers is made from an optically transparent material. For example, the optically transparent antenna can have two film layers, each made from the same conductive and optically transparent material.

In some implementations, the optically transparent antenna has a single film layer made from a conductive and optically transparent material. As an example, the optically transparent antenna is constructed by disposing a layer of conductive and optically transparent material on a substrate to create a film. The substrate itself can also be optically transparent.

In some implementations, the optically transparent antenna is an antenna array constructed using two or more layers of film stacked on top of one another. The use of additional layers of film can improve the conductivity of the antenna and, thereby, the radiation efficiency. As an example, the optically transparent antenna is an antenna array formed from stacking two layers of conductive film, where one or both of the layers of conductive film are optically transparent. As another example, the optically transparent antenna is an antenna array formed from stacking three layers of conductive film, where one, two, or all three of the layers of conductive film are optically transparent.

In some implementations, one or more of the optically transparent antennas are used in a communication system to transmit communication signals, receive communication signals, or both. For example, a communication system can include (i) a transmitter (e.g., signal generator) for generating signals connected to a first antenna for transmitting the generated signals and (ii) a receiver (e.g., signal analyzer) for processing signals connected to a second antenna for receiving the transmitted signals. At least one of the first antenna and the second antenna is an optically transparent antenna as described herein. As another example, a communication system can include a transceiver for generating and processing signals connected to an optically transparent antenna, where the optically transparent antenna is capable of transmitting signals generated by the transceiver and receiving signals from external sources that are then processed by the transceiver.

In one general aspect, an optically transparent antenna includes: a substrate layer; a first conductive layer formed on the substrate layer, where (i) a length of the conductive layer is greater than a width of the first conductive layer and (ii) the width of the first conductive layer is at least one eighth the length of the conductive layer; where the first conductive layer is optically transparent such that the first conductive layer exhibits optical transmission of approximately 80% or more.

In some implementations, the first conductive layer exhibits optical transmission of at least 90%.

In some implementations, a ratio of the width of the first conductive layer to the length of the first conductive layer is between 0.5 and 0.9.

In some implementations, the ratio of the width of the first conductive layer to the length of the conductive layer is or substantially is 0.8.

In some implementations, the first conductive layer is a layer of one of the following materials: silver-nanowire (AgNW), carbon nanotube (CNT), a hybrid material that combines carbon nanotube and silver-nanowire (AgNW), graphene, indium tin oxide (ITO), gallium-doped zinc oxide (GZO), aluminum-doped zinc oxide (AZO), a Copper-silver-nanowire (AgNW) hybrid or network material, or a Aluminum-doped Zinc Oxide (AZO)-silver-nanowire (AGNW)-Aluminum-doped Zinc Oxide (AZO) hybrid or network material.

In some implementations, the antenna includes a second conductive layer arranged below the conductive layer such that the conductive layer and the second conductive layer overlap, where (i) a length of the second conductive layer is greater than a width of the second conductive layer and (ii) the width of the second conductive layer is at least one eighth the length of the second conductive layer, where the second conductive layer is optically transparent such that the second conductive layer exhibits optical transmission of approximately 80% or more.

In some implementations, a length of the second conductive layer is the same or substantially the same as the length of the first conductive layer; a width of the second conductive layer is the same or substantially the same as the width of the first conductive layer; a top surface of the first conductive layer is located in a first plane; and a top surface of the second conductive layer is located in a second plane parallel or substantially parallel to the first plane.

In some implementations, a thickness of the second conductive layer is the same or is substantially the same as a thickness of the first conductive layer.

In some implementations, the first conductive layer and the second conductive layer each exhibit an optical transmission of at least 90%.

In some implementations, a thickness of the first conductive layer is less than 100 nm; and a thickness of the second conductive layer is less than 100 nm.

In some implementations, a ratio of the width of the first conductive layer to the length of the first conductive layer is between 0.5 and 0.9; and a ratio of the width of the second conductive layer to the length of the second conductive layer is between 0.5 and 0.9.

In some implementations, the ratio of the width of the first conductive layer to the length of the first conductive layer is or substantially is 0.8; and the ratio of the width of the second conductive layer to the length of the second conductive layer is or substantially is 0.8.

In some implementations, the first conductive layer is electrically connected to a device capable of introducing a current in the conductive layer; and the first conductive layer and the second conductive layer are arranged sufficiently close to one another such that, when current is introduced by the device in the first conductive layer, approximately the same level of current is introduced in the second conductive layer by electrical coupling between the first conductive layer and the second conductive layer.

In some implementations, the antenna is configured such that the second conductive layer is dependent on current being introduced in the first conductive layer by the device for current to be introduced in the second conductive layer.

In some implementations, the first conductive layer is electrically connected to a device; the second conductive layer is electrically connected to the device; and the device is capable of introducing a current in the first conductive layer and the second conductive layer.

In some implementations, the antenna includes a third conductive layer arranged below the first conductive layer and the second conductive layer, where (i) a length of the third conductive layer is greater than a width of the third conductive layer and (ii) the width of the third conductive layer is at least one eighth the length of the third conductive layer; where a length of the third conductive layer is the same or substantially the same as the length of the first conductive layer and the second conductive layer; where a width of the third conductive layer is the same or substantially the same as the width of the first conductive layer and the second conductive layer; and where a top surface of the third conductive layer is located in a third plane parallel or substantially parallel to the first plane and the second plane; where the third conductive layer is optically transparent.

In some implementations, the first conductive layer and the second conductive layer fully overlap.

In some implementations, the antenna is a dipole antenna.

In another general aspect, a method for fabricating an optically transparent antenna includes: depositing a first film of an optically transparent material on a first side of a first substrate such that the length of the first film is greater than a width of the first film; depositing a second film of material on a first side of a second substrate that the length of the second film is greater than a width of the second film; joining a bottom surface of the first substrate to a top surface of the second film such that (i) the second film is placed below the first film and (ii) the first film and the second film overlap; and electrically coupling the first film to a transmitter, receiver, or transceiver.

In another general aspect, a method for fabricating an optically transparent antenna includes: depositing a first film of an optically transparent material on a first side of a first substrate such that the length of the first film is greater than a width of the first film; depositing a second film of material on a second side of the first substrate such that (i) the length of the second film is greater than a width of the second film, (ii) the second film is placed below the first film, and (iii) the first film and the second film overlap; and electrically coupling at least one of the first film and the second film to a transmitter, receiver, or transceiver.

A number of benefits are realized using the described film layer geometry for one or more film layers of an optically transparent antenna. For example, increasing the width-to-length ratio of the film layer (e.g., where the film layer has a width, length, and thickness; the width is substantially larger than the thickness; the length is substantially larger than the thickness; and the width-to-length ratio is the ratio of the width of the film layer to the length of the film layer such that the width-to-length ratio is calculable as the width of the film layer divided by the length of the film layer) reduces loss resistance of the antenna and improves radiation efficiency. However, if the ratio is increased beyond a certain point, the nature of the antenna's radiation is altered such that the direction of the current changes, resulting in a change to the antenna's polarization. As an example, one solution described in more detail below is to construct an antenna using a single transparent conductive film (TCF) having a width-to-length ratio of 80%. Such an antenna is able to achieve a radiation efficiency of at approximately 50% or better without altering the nature of the antenna's radiation. Therefore, a film layer geometry as described herein achieves an excellent antenna efficiency without altering the nature of the antenna's radiation. As a result, the optically transparent antenna described is, among other things, able to transmit signals a longer distance without sacrificing signal quality.

Additional benefits are achieved by constructing the optically transparent antenna from multiple layers of film. For example, TCFs typically lose much or all of their transparency beyond a certain thickness. At the same time, radiation efficiency of an antenna is reduced as the thickness of the conductor (e.g., the TCF) of the antenna is reduced. A solution to this problem is described herein where an optically transparent antenna is constructed by stacking multiple layers of film (e.g., TCF). Each layer of film can be made from an optically transparent material and be thin enough to maintain optical transparency. Together, the set of layers operate as a conductor with increased thickness compared to the thickness of the individual layers of film. In turn, the radiation efficiency of the optically transparent antenna is improved. As a result, the optically transparent antenna described is, among other things, able to transmit signals a longer distance.

Furthermore, optically transparent antennas provide a number of benefits in their ability to be seamlessly integrated with many objects. For example, optically transparent antennas can be seamlessly integrated with various types of screens or displays, window glass, windshields, and relay antennas for 5G or 6G applications. In more detail, numerous and significant applications are achieved by integrating optically transparent antennas on glass doors and windows, with glasses and/or contact lens, with optical sensors enabling next generation communication, medicine, smart cars, smart houses, and for security applications, etc.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a communication system that includes one or more optically transparent antennas.

FIG. 2A is a perspective view of an exemplary optically transparent antenna with a single film layer.

FIG. 2B is a perspective view of an exemplary optically transparent antenna with two film layers.

FIG. 2C is a perspective view of an exemplary optically transparent antenna with three film layers.

FIG. 2D is a perspective view of an exemplary optically transparent antenna with two film layers.

FIG. 3A is an exemplary circuit diagram for the example optically transparent antenna shown in FIG. 2A.

FIG. 3B is an exemplary circuit diagram for the example optically transparent antenna shown in FIG. 2B and FIG. 2D.

FIG. 3C is an exemplary circuit diagram for the example optically transparent antenna shown in FIG. 2C.

FIG. 4 is a flow chart depicting an example process for fabricating an optically transparent antenna.

FIG. 5 is a graph of a frequency response comparison between new and old silver nanowire-based antenna.

FIG. 6 is a graph of a frequency response comparison between new and old hybrid-based antenna.

FIG. 7 shows an exemplary schematic for a DC power test setup.

FIGS. 8A-8B show exemplary optically transparent material and effects of DC power on the material.

FIGS. 9A-9B show exemplary optically transparent material and effects of DC power on the material.

FIG. 10 shows an exemplary schematic of a sample for a radiofrequency power test.

FIG. 11 shows an example of a system for testing an optically transparent antenna.

FIG. 12 shows an exemplary circuit diagram for an AC power test setup.

FIG. 13 is an exemplary graph showing the alternating current impedance characteristics for different optically transparent materials.

FIGS. 14A-14B shows exemplary graphs showing simulated radiation patterns for different optically transparent materials.

FIGS. 15A-15B show exemplary schematics for a test fixture for testing an optically transparent antenna.

FIGS. 16A-16C show exemplary test fixtures for testing an optically transparent antenna.

FIG. 17 shows an exemplary optically transparent antenna mounted to a test fixture.

FIGS. 18A-18D shows exemplary graphs depicting an optically transparent antenna response at different frequencies.

FIGS. 19A-19B show exemplary antennas.

FIG. 20 shows an example of a test system for testing an optically transparent antenna.

Like reference numbers and designations in the various drawings indicate like elements.

### DETAILED DESCRIPTION

An optically transparent antenna and antenna array is described herein. Antennas made from transparent conducting materials can be used in various applications without the need of much space and also because of the opto-electrical properties and flexible form factor. The combination of more than one transparent conductor in an antenna further increases the efficiency of such antennas and usability of transparent and conductive materials in antennas.

In some implementations, the optically transparent antenna is constructed using one or more layers of film. The geometry of the layers is designed to reduce or minimize loss resistance and, thereby, improve the radiation efficiency and gain of the antenna. Each layer of film can have a width less than its length and greater than an eighth of its length. For example, the optically transparent antenna can have two layers of rectangular-shaped film where the width of each of the layers is or approximately is 80% of the length of each of the layers. In some implementations, each layer of film of the optically transparent antenna is made from a conductive material. In some implementations, at least one of the one or more film layers is made from an optically transparent material. For example, the optically transparent antenna can have two film layers, each made from the same conductive and optically transparent material.

As used throughout, the term “optically transparent” film or material refers to a layer of material exhibiting approximately 80% or more optical transmission. As an example, an optically transparent film can exhibit 95% optical transmission.

As used throughout, the term “optically transparent antenna” refers to an antenna having at least one component made from optically transparent film or material. As an example, an optically transparent antenna can include one or more layers of optically transparent film each exhibiting 95% optical transmission. In more detail, if the optically transparent antenna is constructed with a single layer of optically transparent film exhibiting 90% optical transmission, the antenna can itself exhibit approximately 90% optical transmission. If, however, the optically transparent antenna is constructed by stacking two or more layers of optically transparent film exhibiting 90% optical transmission, the antenna will exhibit a lower optical transmission of approximately 80% but will exhibit higher conductivity, increasing radiation efficiency and, therefore, signal distance.

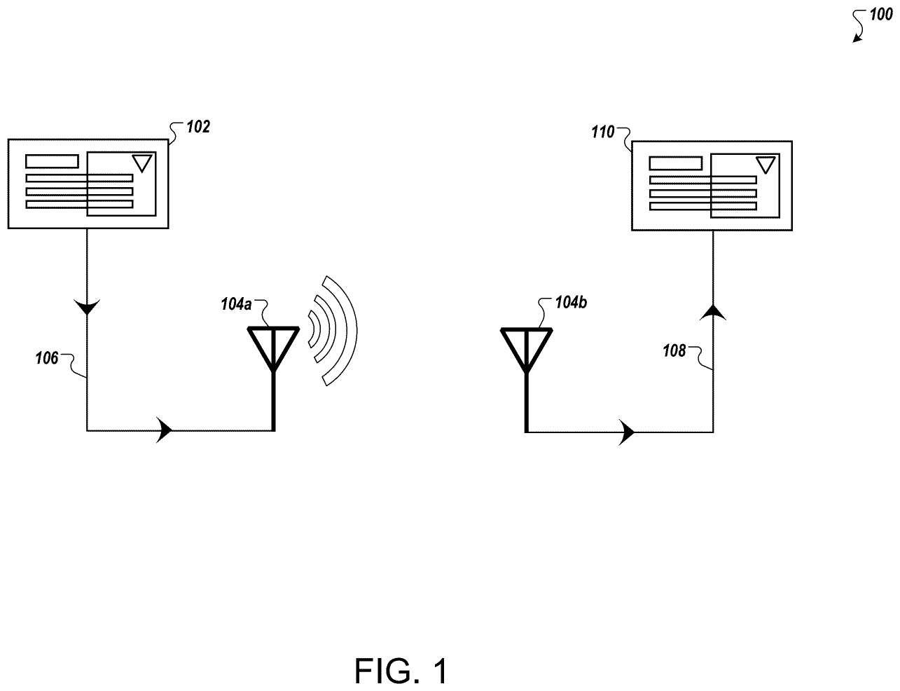

FIG. 1 is a diagram showing an example of a communication system 100 that includes one or more optically transparent antennas. The communication system 100 includes a first antenna 104a used to transmit signals and a second antenna 104b used to receive signals. In some implementations, the first antenna 104a is an optically transparent antenna. In some implementations, the second antenna 104b is an optically transparent antenna. In some implementations, both the first antenna 104a and the second antenna 104b are optically transparent antennas. The communication system also includes a transmitter 102 (e.g., signal generator) electrically connected to the first antenna 104a through a first electrical connection 106 (e.g., wire(s), cable, etc.) and a receiver 110 (e.g., signal analyzer) electrically connected to the second antenna 104b through a second electrical connection 108 (e.g., wire(s), cable, etc.). The transmitter 102 is able to generate communication signals that are wirelessly transmitted by the first antenna 104a. The receiver 110 is able to process communication signals wirelessly received by the second antenna 104b.

In some implementations, the transmitter 102 is a transceiver capable of generating communication signals and processing communication signals.

In some implementations, the receiver 102 is a transceiver capable of processing and transmitting communication signals.

An optically transparent antenna such as the antenna 104a and/or the antenna 104b can operate in one or more frequency ranges. The table below lists the frequency bands and letter band nomenclature according to the IEEE 521-2002 standards. As an example, an optically transparent antenna such as the antenna 104a and/or the antenna 104b can operate in any of the frequency ranges listed in the table below, such as at 2 GHz in the L or S band, 3.75 GHz in the S band, or 5 GHz in the C band.

| Band | Frequency Range | | Wavelength |
|---|---|---|---|
| HF | 3 MHz to 30 MHz | | 10 meters to 1 meter |
| VHF | 30 | MHz-300 MHz | 1,000 cm to 100 cm |
| UHF | 300 | MHz-1 GHz | 100 cm to 30 cm |
| L band | 1 | GHz-2 GHz | 30 cm to 15 cm |
| S band | 2 | GHz-4 GHZ | 15 cm to 7.5 cm |
| C band | 4 | GHz-8 GHZ | 7.5 cm to 3.8 cm |
| X band | 8 | GHz-12 GHz | 3.8 cm to 2.5 cm |
| Ku band | 12 | GHz-18 GHz | 2.5 cm to 1.7 cm |
| K band | 18 | GHz-27 GHz | 1.7 cm to 1.1 cm |
| Ka band | 27 | GHz-40 GHz | 1.1 cm to 0.75 cm |
| V band | 40 | GHz-75 GHz | 0.75 cm to 0.40 cm |
| W band | 75 | GHz-100 GHz | 0.40 cm to 0.27 cm |
| mm | 110 | GHz-300 GHz | 0.27 cm to 0.10 cm |

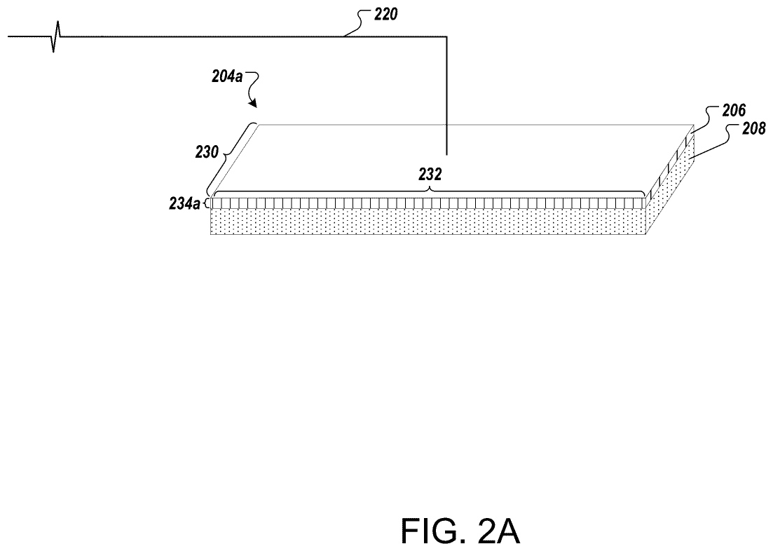

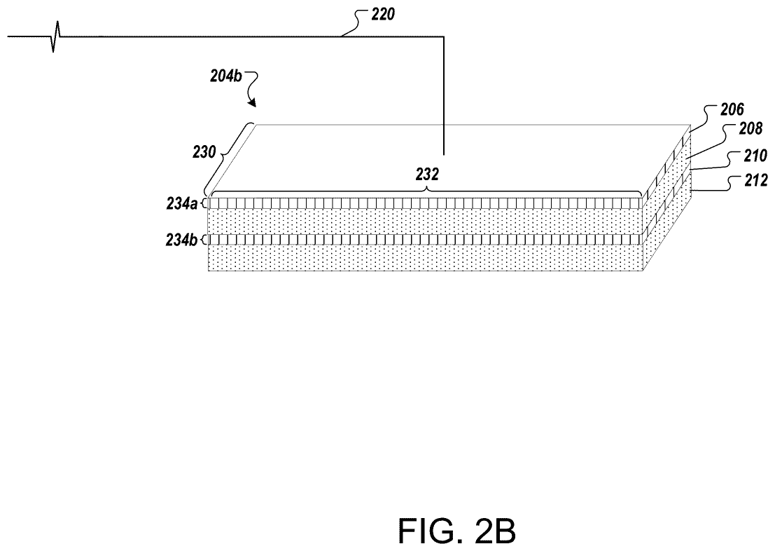

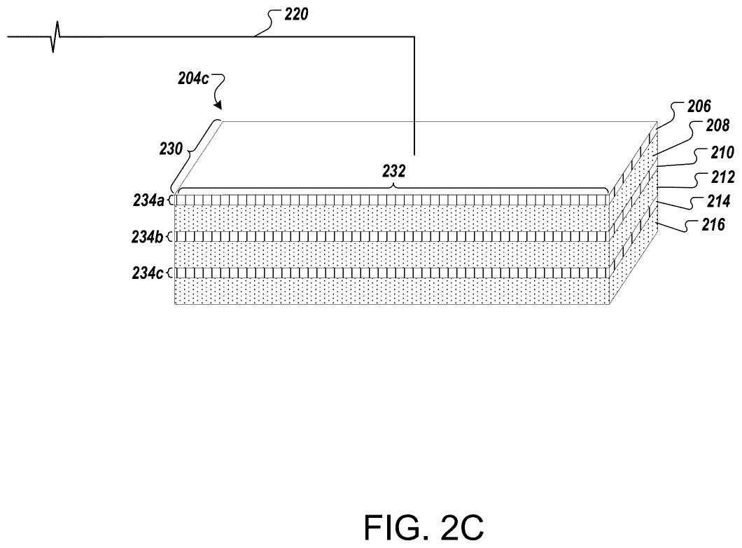

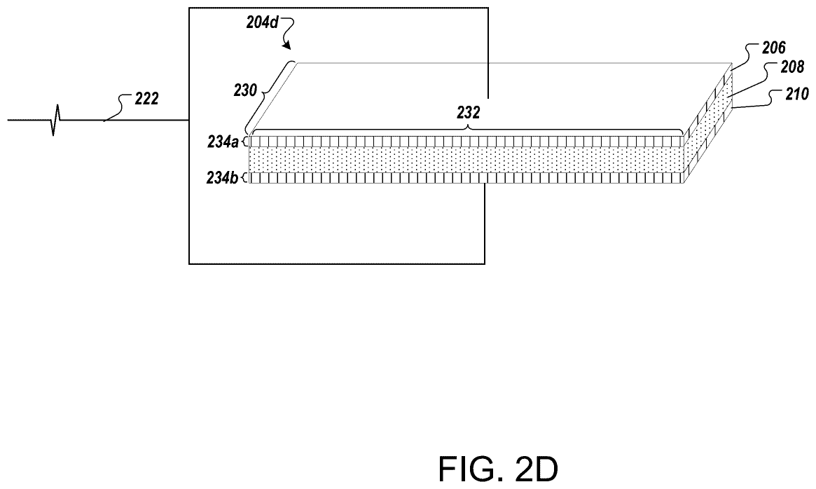

FIG. 2A is a perspective view of an exemplary optically transparent antenna 204a with a single film layer. As shown, the antenna 204a includes a single layer of film 206 having a width 230, a length 232, and a thickness 234a. The layer of film 206 is disposed on a substrate 208. The layer of film 206 of the antenna 204a is electrically coupled to one or more components through an electrical connection 220. The one or more components can include, for example, a transmitter, a receiver, a transceiver, or the like.

As shown in FIG. 2A, the layer of film 206 has a length greater than its width. Increasing the width-to-length ratio of the film 206 (e.g., where the film 206 has a width, length, and thickness; the width of the film 206 is substantially larger than the thickness of the film 206; the length of the film 206 is substantially larger than the thickness of the film 206; and the width-to-length ratio is the ratio of the width of the film 206 to the length of the film 206 such that the width-to-length ratio is calculable as the width of the film 206 divided by the length of the film 206) reduces loss resistance of the antenna 204a and improves radiation efficiency and gain of the antenna 204a. However, if the width-to-length ratio is increased beyond a certain point, the nature of the antenna 204a's radiation can be altered such that the direction of the current changes, resulting in a change to the antenna 204a's polarization. For this reason, the width-to-length ratio of the film 206 should not exceed 1.0 and, ideally, should not substantially exceed 0.8. In some implementations, the width-to-length ratio of the film 206 is between 0.125 and 0.8. In some implementations, the width-to-length ratio of the film 206 is between 0.5 and 0.8. In some implementations, the width-to-length ratio of the film 206 is or approximately is 0.8.

In some implementations, the optically transparent antenna 204a is a dipole antenna. As an example, the optically transparent antenna 204a is a flat dipole antenna (e.g., cuboid in shape). As another example, the optically transparent antenna 204a is a thin, flat dipole antenna (e.g., where the width and length of the antenna are significantly larger than a thickness of the antenna).

In some implementations, the optically transparent antenna 204a is a monopole antenna. As an example, the optically transparent antenna 204a is a flat monopole antenna (e.g., cuboid in shape). As another example, the optically transparent antenna 204a is a thin, flat monopole antenna (e.g., where the width and length of the antenna are significantly larger than a thickness of the antenna).

In some implementations, the film 206 is optically transparent material such that the film 206 exhibits optical transmission of approximately 80% or more. As an example, the film 206 exhibits optical transmission of approximately 80%, 84%, 85%, 86%, 87%, 89%, 90%, 92%, 93%, 94%, or 95%. As another example, the film 206 exhibits optical transmission between 80% and 96%, between 80% and 90%, between 80% and 88%, between 80% and 86%, between 80% and 84%, between 80% and 82%, between 82% and 92%, between 82% and 90%, between 82% and 88%, between 82% and 86%, between 82% and 84%, between 84% and 92%, between 84% and 90%, between 84% and 88%, between 84% and 86%, between 86% and 92%, between 86% and 90%, between 86% and 88%, between 88% and 92%, between 88% and 90%, or between 90% and 92%.

In some implementations, the film 206 is made from a conductive material that permits transmission of electric current. As an example, the film 206 can be a metal film or metallic oxide film. In more detail, the film 206 can be made from copper, aluminum, or iron.

In some implementations, the film 206 is optically transparent and conductive. As an example, the film 206 is a transparent conductive film (TCF) that is able to transmit electric currents while retaining transparent properties. Examples of such materials used to make TCFs include transparent conducting oxides (TCOs) such as indium tin oxide (ITO) and aluminum doped zinc oxide (ZnO:Al). Other examples of such materials used to make TCFs include silver nanowire (AgNW), carbon nanotube (CNT), and hybrid materials such as hybrid films made from silver nanowires and single walled carbon nanotubes.

In some implementations, the substrate 208 is optically transparent such that the substrate 208 exhibits optical transmission of approximately 80% or more. As an example, the substrate 208 is glass. As another example, the substrate 208 is polyethylene terephthalate (PET).

In some implementation, the thickness 234a of the film 206 is less than 100 nm. As an example, the thickness 234a of the film 206 is between 10 nm and 50 nm. As another example, the thickness 234a of the film 206 is or approximately is 20 nm.

In some implementations, the antenna 204a is constructed by disposing a layer of transparent and conductive material onto the substrate 208 to form the film 206. As an example, the geometry of the film 206 with its width 230, length 232, and thickness 234a is realized through the process of disposing the layer of transparent and conductive material onto the substrate 208. As another example, the geometry of the film 206 with its width 230, length 232, and thickness 234a is realized through the process of disposing the layer of transparent and conductive material onto the substrate 208 to achieve the thickness 234a and removing material to achieve the width 230 and length 232 and/or the rectangular shape of the film 206.

In some implementations, the film 206 is excited through signals transmitted across the electrical connection 220. As an example, a transmitter is electrically coupled to the film 206 of the antenna 204a through the electrical connection 220 and the transmitter sends a signal to the antenna 204a through the electrical connection 220, resulting in current passing through the film 206 and, therefore, the film 206 becoming excited.

In some implementations, the film 206 is excited through wireless signals received by the antenna 204a. As an example, the antenna 204a receives wireless communication signals that generate current in the film 206 and, therefore, excite the film 206. The communication signal can be passed from the antenna 204a to a receiver electrically coupled to the film 206 of the antenna 204a through the electrical connection 220.

FIG. 2B is a perspective view of an exemplary optically transparent antenna 204b with two film layers 206 and 210. As shown, the antenna 204b includes the layer of film 206 disposed on the substrate 208 as described in more detail above with respect to FIG. 2A and a second layer of film 210 disposed on a second substrate 212. In the example of FIG. 2B, both the first layer of film 206 and the second layer of film 210 have the width 230 and the length 232. The first layer of film 206 has the thickness 234a and the second layer of film 210 has a thickness 234b. The layer of film 206 of the antenna 204b is electrically coupled to one or more components through the electrical connection 220 described in more detail above with respect to FIG. 2A. However, the second layer of film 210 is not electrically coupled to the one or more components. The one or more components can include, for example, a transmitter, a receiver, a transceiver, or the like.

As shown in FIG. 2B, the second layer of film 210 has a length greater than its width. Increasing the width-to-length ratio of the film 210 (e.g., where the film 210 has a width, length, and thickness; the width of the film 210 is substantially larger than the thickness of the film 210; the length of the film 210 is substantially larger than the thickness of the film 206; and the width-to-length ratio is the ratio of the width of the film 210 to the length of the film 206 such that the width-to-length ratio is calculable as the width of the film 210 divided by the length of the film 206) reduces loss resistance of the antenna 204b and improves radiation efficiency and gain of the antenna 204b. However, if the width-to-length ratio is increased beyond a certain point, the nature of the antenna 204b's radiation can be altered such that the direction of the current changes, resulting in a change to the antenna 204b's polarization. For this reason, the width-to-length ratio of the second film 210 should not exceed 1.0 and, ideally, should not substantially exceed 0.8. In some implementations, the width-to-length ratio of the second film 210 is between 0.125 and 0.8. In some implementations, the width-to-length ratio of the second film 210 is between 0.5 and 0.8. In some implementations, the width-to-length ratio of the second film 210 is or approximately is 0.8.

As shown in FIG. 2B, the second layer of film 210 and the substrate 212 are joined to the first layer of film 206 and the substrate 208. For example, the second layer of film 210 and the substrate 212 are stacked below the first layer of film 206 and the substrate 208 such that a top surface of the film 210 contacts a bottom surface of the substrate 208. Together, the set of layers of film 206 and 210 operate as a conductor with increased thickness compared to the thickness of the individual layers of film 206 and 210 which increases the radiation efficiency and gain of the optically transparent antenna 204b and, therefore, the distance that the antenna 204b can transmit communication signals. In more detail, as a result of optimizing the geometries of film layers and stacking two or more layers of film (e.g., TCF), the antenna 204b can achieve a radiation of efficiency of at least 57% and, in some implementations, more than 60% depending on the materials selected for the first film 206 and the second film 210.

In some implementations, joining the first layer of film 206 and the substrate 208 with the second layer of film 210 and the substrate 212 includes using an adhesive. As an example, joining the two layers of film and substrate includes coating the second layer of film 210 (e.g., top surface of the second layer of film 210) and/or the substrate 212 with an adhesive and stacking the first layer of film 206 and the substrate 208 on top of the second layer of film 210 and the substrate 212 to construct the antenna 204b.

In some implementations, the adhesive used to join the film and/or substrate layers is optically transparent. For example, the layer of adhesive coated on the top surface of the second layer of film 210 and used to join the top surface of the second layer of film 210 to a bottom surface of the substrate 208 exhibits optical transmission of approximately 80% or more (e.g., greater than equal to 90% optical transmission).

In some implementations, the adhesive used to join the film and/or substrate layers is electrically non-conductive and/or an electrical insulator. For example, the layer of adhesive coated on the top surface of the second layer of film 210 and used to join the top surface of the second layer of film 210 to a bottom surface of the substrate 208 is made from a nonconductive adhesive containing silica or alumina fillers.

In some implementations, joining the first layer of film 206 and the substrate 208 with the second layer of film 210 and the substrate 212 includes using a fastener to hold or secure the layers together. As an example, the first layer of film 206 and the substrate 208 is secured to the second layer of film 210 and the substrate 212 using a clamp.

In some implementations, the second layer of film 210 is coated or disposed on a second side of the substrate 208 as shown and described in more detail below with respect to FIG. 2D.

As shown in FIG. 2B, the first layer of film 206 and the second layer of film 210 overlap. As an example, the first layer of film 206 and the second layer of film 210 completely overlap such that when the antenna 204b is viewed from directly above, the first layer of film 206 fully covers the second layer of film 210, and when the antenna 204b is viewed from directly below the second layer of film 210 fully covers the first layer of film 206.

In some implementations, the optically transparent antenna 204b is a dipole antenna. As an example, the optically transparent antenna 204b is a flat dipole antenna (e.g., cuboid in shape). As another example, the optically transparent antenna 204b is a thin, flat dipole antenna (e.g., where the width and length of the antenna are significantly larger than a thickness of the antenna).

In some implementations, the optically transparent antenna 204b is a monopole antenna. As an example, the optically transparent antenna 204b is a flat monopole antenna (e.g., cuboid in shape). As another example, the optically transparent antenna 204b is a thin, flat monopole antenna (e.g., where the width and length of the antenna are significantly larger than a thickness of the antenna).

In some implementations, the film 210 is optically transparent such that the film 210 exhibits optical transmission of approximately 80% or more. As an example, the film 210 exhibits optical transmission of approximately 80%, 84%, 85%, 86%, 87%, 89%, 90%, 92%, 93%, 94%, or 95%. As another example, the film 210 exhibits optical transmission between 80% and 96%, between 80% and 90%, between 80% and 88%, between 80% and 86%, between 80% and 84%, between 80% and 82%, between 82% and 92%, between 82% and 90%, between 82% and 88%, between 82% and 86%, between 82% and 84%, between 84% and 92%, between 84% and 90%, between 84% and 88%, between 84% and 86%, between 86% and 92%, between 86% and 90%, between 86% and 88%, between 88% and 92%, between 88% and 90%, or between 90% and 92%.

In some implementations, the first film 206 and the second film 210 are both optically transparent. In some implementations, the first film 206 is optically transparent and the second film 210 is not optically transparent such that the second film 210 exhibits an optical transmission of less than approximately 80%.

In some implementations, the film 210 is made from a conductive material that permits transmission of electric current. As an example, the film 210 can be a metal film or metallic oxide film. In more detail, the film 210 can be made from copper, aluminum, or iron.

In some implementations, the first film 206 and the second film 210 are both made from conductive materials. As an example, the film 206 and the film 210 are both made from copper, aluminum, or iron.

In some implementations, the film 210 is optically transparent and conductive. As an example, the film 210 is a transparent conductive film (TCF) that is able to transmit electric currents while retaining transparent properties. Examples of such materials used to make TCFs include transparent conducting oxides (TCOs) such as indium tin oxide (ITO) and aluminum doped zinc oxide (ZnO:Al). Other examples of such materials used to make TCFs include silver nanowire (AgNW), carbon nanotube (CNT), and hybrid materials such as hybrid films made from silver nanowires and single walled carbon nanotubes.

In some implementations, the first film 206 and the second film 210 are both optically transparent and conductive. As an example, the film 206 and the film 210 are both TCFs.

In some implementations, the first film 206 and the second film 210 are both made from the same material. As an example, the first film 206 and the second film 210 are both made from silver nanowire and the thickness 234a of the first film 206 and the thickness 234b of the second film are the same or are substantially the same.

In some implementations, the first film 206 and the second film 210 are made from different materials. As an example, the first film 206 is made from silver nanowire and the second film 210 is made from carbon nanotubes. In this example, the thickness 234a of the first film 206 may be larger or smaller than the thickness 234b of the second film.

In some implementations, the substrate 212 is optically transparent material. As an example, the substrate 212 is glass. As another example, the substrate 212 is polyethylene terephthalate (PET).

In some implementations, the first substrate 208 and the second substrate 212 are made from the same material. As an example, the first substrate 208 and the second substrate 212 are both made from PET.

In some implementation, the thickness 234b of the film 210 is less than 100 nm. As an example, the thickness 234b of the film 210 is between 10 nm and 50 nm. As another example, the thickness 234b of the film 210 is or approximately is 20 nm.

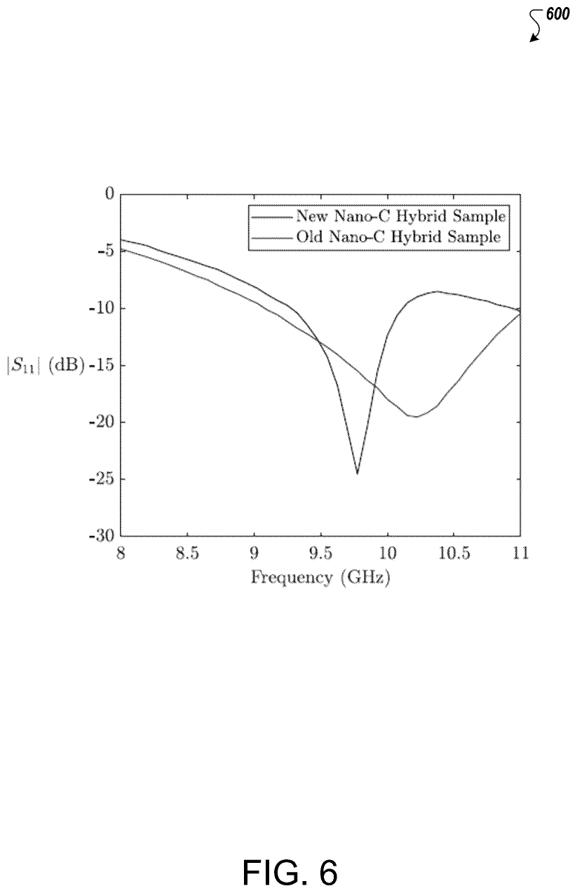

In some implementations, the antenna 204b is constructed by disposing a first layer of transparent and conductive material onto the first substrate 208 to form the first film 206, disposing a second layer of material onto a second substrate 212 to form the second film 210, and stacking the first film 206 and the first substrate 208 on top of the second film 210 and the second substrate 212. Further details about the construction of an optically transparent antenna such as the antenna 204b are described in more detail above with respect to FIG. 2A and below with respect to FIG. 4.

In some implementations, the second film 210 is excited through electrical coupling with the first film 206 such that when the first film 206 (e.g., top layer) is excited, the second film 210 is also excited. For example, due to the close vicinity of the two films 206 and 210, the current excited in the first film 206 couples to the second film 210, forming a two-element antenna array. The magnitude of the current in the second film 210 is approximately the same as the current in the first film 206 due to the closeness in spacing between the two films and the phase difference is inconsequential (e.g., approximately zero) as it based on the distance between the two films.

In some implementations, the film 210 is excited by wireless signals received by the antenna 204b. As an example, the antenna 204b receives wireless communication signals that generate current in one or more of the films 206 and the film 210. When current is passed through one of the films and film becomes excited, the other film(s) become excited through electrical coupling. The communication signal can be passed from the antenna 204b to a receiver or transceiver electrically coupled to the film 206 of the antenna 204b through the electrical connection 220.

FIG. 2C is a perspective view of an exemplary optically transparent antenna 204c with three film layers 206, 210, and 214. As shown, the antenna 204c includes the layer of film 206 disposed on the substrate 208 as described in more detail above with respect to FIGS. 2A-2B, the second layer of film 210 disposed on a second substrate 212 as described in more detail above with respect to FIG. 2B, and a third layer of film 214 disposed on a third substrate 216. In the example of FIG. 2C, both the first layer of film 206, the second layer of film 210, and the third layer of film 214 have the width 230 and the length 232. The first layer of film 206 has the thickness 234a, the second layer of film 210 has the thickness 234b, and the third layer of film 214 has the thickness 234c. The layer of film 206 of the antenna 204b is electrically coupled to one or more components through the electrical connection 220 described in more detail above with respect to FIG. 2A. However, the second layer of film 210 and the third layer of film 214 are not electrically coupled to the one or more components. The one or more components can include, for example, a transmitter, a receiver, a transceiver, or the like.

As shown in FIG. 2C, the third layer of film 214 has a length greater than its width. Increasing the width-to-length ratio of the film 214 (e.g., where the film 214 has a width, length, and thickness; the width of the film 214 is substantially larger than the thickness of the film 214; the length of the film 214 is substantially larger than the thickness of the film 214; and the width-to-length ratio is the ratio of the width of the film 214 to the length of the film 214 such that the width-to-length ratio is calculable as the width of the film 214 divided by the length of the film 214) reduces loss resistance of the antenna 204c and improves radiation efficiency and gain of the antenna 204c. However, if the width-to-length ratio is increased beyond a certain point, the nature of the antenna 204c's radiation can be altered such that the direction of the current changes, resulting in a change to the antenna 204c's polarization. For this reason, the width-to-length ratio of the third film 214 should not exceed 1.0 and, ideally, should not substantially exceed 0.8. In some implementations, the width-to-length ratio of the third film 214 is between 0.125 and 0.8. In some implementations, the width-to-length ratio of the third film 214 is between 0.5 and 0.8. In some implementations, the width-to-length ratio of the third film 214 is or approximately is 0.8.

As shown in FIG. 2C, the third layer of film 214 and the substrate 216 are joined to the second layer of film 210 and the substrate 212. For example, the third layer of film 214 and the substrate 216 are stacked below the second layer of film 210 and the substrate 212 such that a top surface of the film 214 contacts a bottom surface of the substrate 212. Together, the set of layers of film 206, 210, and 214 operate as a conductor with increased thickness compared to the thickness of the individual layers of films 206, 210, and 214 or the thickness of the two layers of films 206 and 210 shown in FIG. 2B. This increases the radiation efficiency and gain of the optically transparent antenna 204c and, therefore, the distance that the antenna 204b can transmit communication signals. In more detail, as a result of optimizing the geometries of film layers and stacking three layers of film (e.g., TCF), the antenna 204c can achieve a radiation of efficiency greater than the efficiency using a single film or two films. However, as a tradeoff, the optical transparency of the antenna 204c is reduced when compared to that of the antenna 204a shown in FIG. 2A and the antenna 204b shown in FIG. 2C.

In some implementations, joining the first layer of film 206 and the substrate 208, the second layer of film 210 and the substrate 212, and the third layer of film 214 and the substrate 216 includes using adhesive. As an example, joining the three layers of film and substrate includes (i) coating the third layer of film 214 (e.g., top surface of the third layer of film 214) and/or the substrate 216 with an adhesive and stacking the second layer of film 210 and the substrate 212 on top of the third layer of film 214 and the substrate 216 and (ii) coating the second layer of film 210 and/or the substrate 212 with an adhesive and stacking the first layer of film 206 and the substrate 208 on top of the combination of the film 210 and 214 and the substrates 212 and 216 to construct the antenna 204c.

In some implementations, the adhesive used to join the film and/or substrate layers is optically transparent. For example, the layer of adhesive coated on the top surfaces of the films 210 and 214 and used to join the top surfaces of the films 210 and 214 to the bottom surface of the substrates 208 and 212, respectively, exhibits optical transmission of approximately 80% or more (e.g., greater than equal to 90% optical transmission).

In some implementations, the adhesive used to join the film and/or substrate layers is electrically non-conductive and/or an electrical insulator. For example, the layer of adhesive coated on the top surfaces of the films 210 and 214 and used to join the top surfaces of the films 210 and 214 to the bottom surface of the substrates 208 and 212, respectively, is made from a nonconductive adhesive containing silica or alumina fillers.

In some implementations, joining the first layer of film 206 and the substrate 208, the second layer of film 210 and the substrate 212, and the third layer of film 214 and the substrate 216 includes using a fastener to hold or secure the layers together. As an example, the films 206, 210, and 214 and the substrates 208, 212, and 214 are secured together using a clamp.

As shown in FIG. 2C, the first layer of film 206, the second layer of film 210, and the third layer of film 214 overlap. As an example, the first layer of film 206, the second layer of film 210, and the third layer of film 214 completely overlap such that when the antenna 204c is viewed from directly above, the first layer of film 206 fully covers the second layer of film 210 and the third layer of film 214, and when the antenna 204c is viewed from directly below the third layer of film 210 fully covers the second layer of film 210 and the first layer of film 206.

In some implementations, the optically transparent antenna 204c is a dipole antenna. As an example, the optically transparent antenna 204c is a flat dipole antenna (e.g., cuboid in shape). As another example, the optically transparent antenna 204c is a thin, flat dipole antenna (e.g., where the width and length of the antenna are significantly larger than a thickness of the antenna).

In some implementations, the optically transparent antenna 204c is a monopole antenna. As an example, the optically transparent antenna 204c is a flat monopole antenna (e.g., cuboid in shape). As another example, the optically transparent antenna 204c is a thin, flat monopole antenna (e.g., where the width and length of the antenna are significantly larger than a thickness of the antenna).

In some implementations, the film 214 is optically transparent such that the film 214 exhibits optical transmission of approximately 80% or more. As an example, the film 214 exhibits optical transmission of approximately 80%, 84%, 85%, 86%, 87%, 89%, 90%, 92%, 93%, 94%, or 95%. As another example, the film 214 exhibits optical transmission between 80% and 96%, between 80% and 90%, between 80% and 88%, between 80% and 86%, between 80% and 84%, between 80% and 82%, between 82% and 92%, between 82% and 90%, between 82% and 88%, between 82% and 86%, between 82% and 84%, between 84% and 92%, between 84% and 90%, between 84% and 88%, between 84% and 86%, between 86% and 92%, between 86% and 90%, between 86% and 88%, between 88% and 92%, between 88% and 90%, or between 90% and 92%.

In some implementations, the first film 206, the second film 210, and the third film 214 are each optically transparent. In some implementations, the first film 206 is optically transparent and one or more of the second film 210 and the third film 214 is not optically transparent such that one or more of the second film 210 and the third film 214 exhibits an optical transmission of less than approximately 80%.

In some implementations, the film 214 is made from a conductive material that permits transmission of electric current. As an example, the film 214 can be a metal film or metallic oxide film. In more detail, the film 214 can be made from copper, aluminum, or iron.

In some implementations, the first film 206, the second film 210, and the third film 214 are each made from conductive materials. As an example, the films 206, 210, and 214 are each made from copper, aluminum, or iron.

In some implementations, the film 214 is optically transparent and conductive. As an example, the film 214 is a transparent conductive film (TCF) that is able to transmit electric currents while retaining transparent properties. Examples of such materials used to make TCFs include transparent conducting oxides (TCOs) such as indium tin oxide (ITO) and aluminum doped zinc oxide (ZnO:Al). Other examples of such materials used to make TCFs include silver nanowire (AgNW), carbon nanotube (CNT), and hybrid materials such as hybrid films made from silver nanowires and single walled carbon nanotubes.

In some implementations, the first film 206, the second film 210, and the third film 214 are each optically transparent and conductive. As an example, the films 206, 210, and 214 are each TCFs.

In some implementations, the first film 206, the second film 210, and the third film 214 are each made from the same material. As an example, the films 206, 210, and 214 are each made from silver nanowire. In this example, the thickness 234a of the first film 206, the thickness 234b of the second film, and the thickness 234c of the third film 214 are each the same or substantially the same.

In some implementations, one or more of the first film 206, the second film 210, and the third film 214 are made from different materials. As an example, the first film 206 is made from silver nanowire and the films 210 and 214 are made from carbon nanotubes. In this example, the thickness 234a of the first film 206 may be larger or smaller than the thickness 234b of the second film and the thickness 234c of the third film.

In some implementations, the substrate 216 is optically transparent material. As an example, the substrate 216 is glass. As another example, the substrate 216 is polyethylene terephthalate (PET).

In some implementations, the first substrate 208, the second substrate 212, and the third substrate 216 are each made from the same material. As an example, the first substrate 208, the second substrate 212, and the third substrate 216 are each made from PET.

In some implementation, the thickness 234c of the film 214 is less than 100 nm. As an example, the thickness 234c of the film 214 is between 10 nm and 50 nm. As another example, the thickness 234c of the film 214 is or approximately is 20 nm.

In some implementations, the antenna 204c is constructed by disposing a first layer of transparent and conductive material onto the first substrate 208 to form the first film 206, disposing a second layer of material onto a second substrate 212 to form the second film 210, stacking the first film 206 and the first substrate 208 on top of the second film 210 and the second substrate 212, disposing a third layer of material onto a third substrate 216 to from the third film 214, and stacking the films 206 and 210 and the substrates 208 and 212 on top of the third film 214 and the third substrate 216. Further details about the construction of an optically transparent antenna such as the antenna 204c are described in more detail above with respect to FIG. 2A and below with respect to FIG. 4.

In some implementations, the third film 214 is excited by electrical coupling with the first film 206 and/or the second film 210 such that when the first film 206 (e.g., top layer) is excited, the second film 210 and the third film 214 are also excited. For example, due to the close vicinity of the three films 206, 210, and 214, the current excited in the first film 206 couples to the second film 210 and the third film 214, forming a three-element antenna array. The magnitude of the current in the third film 210 is approximately the same as the current In the first film 206 and the second film 210 due to the closeness in spacing between the three films and the phase difference is inconsequential (e.g., is approximately zero) as it based on the distance between the films.

In some implementations, the film 214 is excited by wireless signals received by the antenna 204c. As an example, the antenna 204c receives wireless communication signals that generate current in one or more of the films 206, 210, and 214. When current is passed through one of the films and film becomes excited, the other films become excited through electrical coupling. The communication signal can be passed from the antenna 204c to a receiver or transceiver electrically coupled to the film 206 of the antenna 204c through the electrical connection 220.

FIG. 2D is a perspective view of an exemplary optically transparent antenna 204d with two film layers 206 and 210. As shown, the antenna 204d includes the layer of film 206 disposed on the substrate 208 as described in more detail above with respect to FIGS. 2A-2B and the second layer of film 210 described in more detail above with respect to FIG. 2B. In the example of FIG. 2D, both the first layer of film 206 and the second layer of film 210 have the width 230 and the length 232. The first layer of film 206 has the thickness 234a and the second layer of film 210 has a thickness 234b. The first layer of film 206 and the second layer of film 210 of the antenna 204d are electrically coupled to one or more components through the electrical connection 222. The one or more components can include, for example, a transmitter, a receiver, a transceiver, or the like.

As shown in FIG. 2D, unlike the antenna 204b described above with respect to FIG. 2B, the second layer of film 210 is disposed on the same substrate 208 as the first layer of film 206. This can be achieved, for example, using a different fabrication process. For example, a first layer of material is disposed on a first surface of the substrate 208 to form the first layer of film 206, the substrate 208 is then turned over, and a second layer of material is disposed on a second surface of the substrate 208 opposite the first surface to form the second layer of film 210. This is a more complicated manufacturing process but has the added benefit of allowing the second layer of film 210 to be electrically connected to one or more components such that the second layer of film 210 can be directly excited along with the first layer of film 206. As a result, the current in the first layer of film 206 matches the current in the second layer of film 210 and there is no phase delay between the two films when excited.

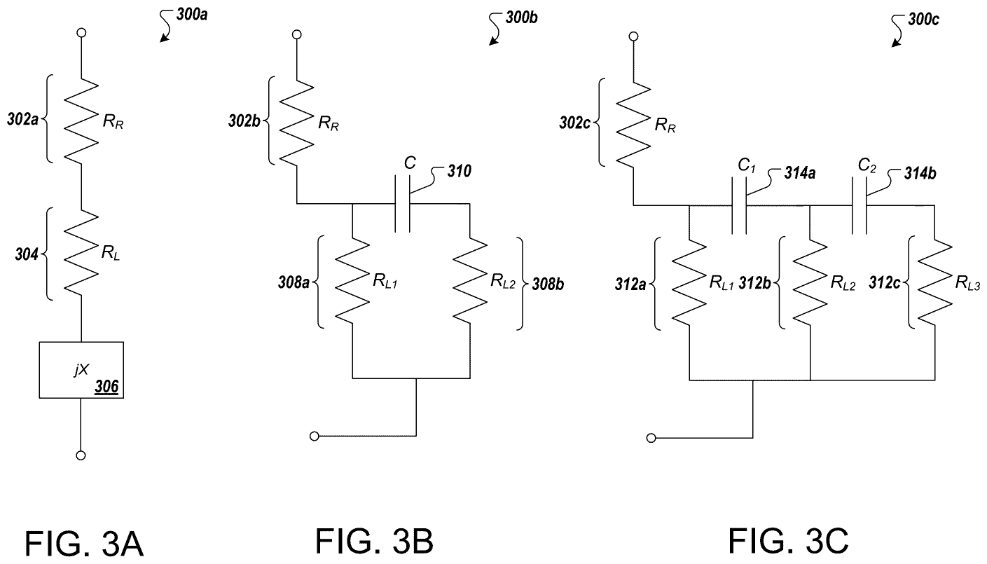

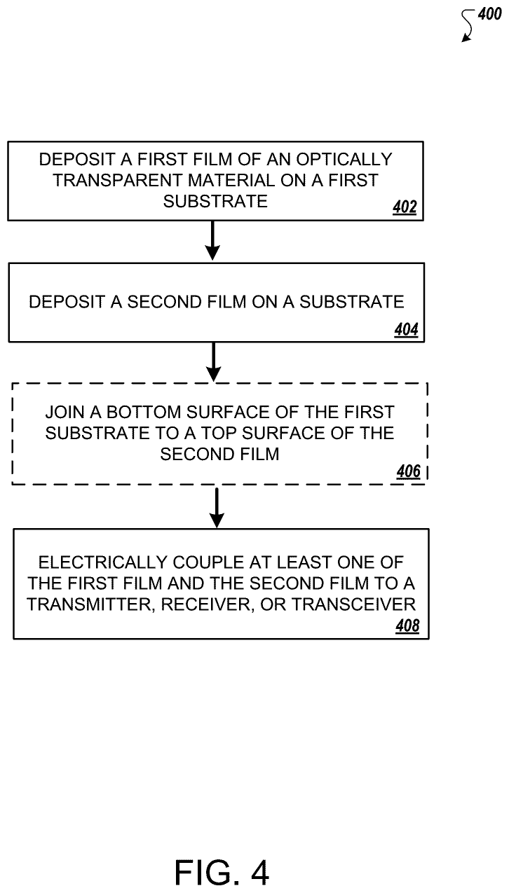

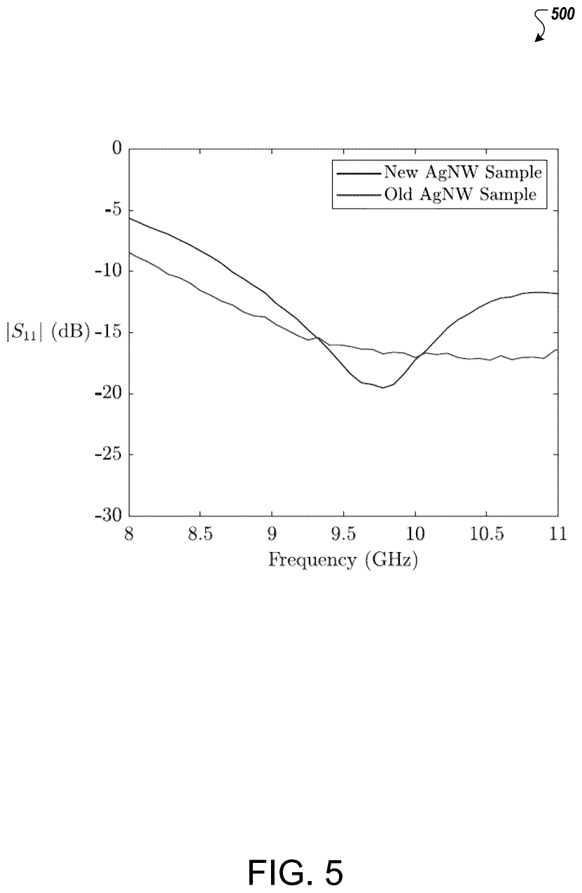

FIG. 3A is an example circuit diagram 300a for the example optically transparent antenna 204a shown in FIG. 2A. The circuit diagram 300a depicts a circuit model for the antenna 204a shown in FIG. 2A. The model includes a radiation resistance 302a (R_{R}), a loss resistance 304 (R_{L}), and a component 306 (jX) that represents that reactive part of the antenna. The loss resistance 304 represents the effective ohmic loss on the antenna, which depends on the material as well as the current distribution. The radiation resistance depends on the radiation pattern and the current distribution. With respect to the component 306, impedance of a reactive circuit component such as an inductor or capacitor is an imaginary number, which can be expressed as jX where j is square root of −1. For example, the impedance of a capacitor with a capacitance of C is −j/(ω*C) where ω is the radian frequency where the capacitor operates at.

As an example, for a resonant type of antenna such as a patch or a dipole antenna, the component 306 is often designed to be zero or near zero.

As an example, an ideal half-wavelength dipole antenna on an infinite ground plane has a radiation resistance 302 of 73 Ohm, and a quarter-wavelength monopole has a radiation resistance 302 of 36.5 Ohm. A flat monopole on a finite ground plane may have a radiation resistance 302 around 40-50 Ohm.

FIG. 3B is an exemplary circuit diagram 300b for the example optically transparent antenna shown in FIG. 2B and FIG. 2D. As an example, the circuit diagram 300b represents a circuit model for two stacked flat dipoles. The model includes a radiation resistance 302b (R_{R}), a first loss resistance 308a (R_{L1}), a second loss resistance 308b (R_{L2}), and a capacitance 310I) that, for example, represents the coupling capacitance between the two dipoles. The two flat dipoles form a parallel plate, permitting the capacitance 310 to be computed from the equation, C=ε(WL/d) where C is the capacitance 310, W is the width of the dipoles (e.g., width of the transparent and conductive films), L is the length of the dipoles (e.g., length of the transparent and conductive films), dis the distance between the dipoles (e.g., distance between the transparent and conductive films), and ε is the permittivity of the substrate where the transparent film is printed on. From this equation, it is seen that C is a relatively large value due to d being relatively small, and, therefore, the impedance of this coupling capacitance 310 is closer to 0. The two loss resistances 308a-308b are connected in parallel since the capacitance 310 is effectively a short circuit. This means the overall loss resistance of a two-layer stacked flat dipole is reduced to half, which then means the improvement of the antenna efficiency can be represented by the following equation: e_{eff}=Rᵣ/(Rᵣ+R_{L/2})>Rᵣ/(Rᵣ+R_{L}).

As an example, the distance dis approximately the thickness of the substrate (e.g., substrate 108 shown in FIG. 2B). In some implementations, the thickness of the substrate and, therefore, the distance dis approximately 100 μm.

FIG. 3C is an exemplary circuit diagram 300c for the example optically transparent antenna shown in FIG. 2C. As an example, the circuit diagram 300c represents a circuit model for three stacked flat dipoles. The model includes a radiation resistance 302c (R_{R}), a first loss resistance 312a (R_{L1}), a second loss resistance 312b (R_{L2}), a third loss resistance 312c (R_{L3}), a capacitance 314a (C₁) that, for example, represents the coupling capacitance between the first and second dipoles, a capacitance 314b (C₂) that, for example, represents the coupling capacitance between the second and third dipoles. Stacking three films can be analyzed in the same fashion and the model as illustrated in FIG. 3B.

FIG. 4 is a flow chart depicting an example process 400 for fabricating an optically transparent antenna. The process can be performed by one or more programmable or computer-controlled machines with or without the assistance of an operator. The process 400 can be performed to fabricate the optically transparent antenna 204a shown in FIG. 2A, the optically transparent antenna 204b shown in FIG. 2B, the optically transparent antenna 204c shown in FIG. 2C, and/or the optically transparent antenna 204d shown in FIG. 2D.

The process 400 includes depositing a first film of an optically transparent material on a first substrate (402). In some implementations, depositing the first film include depositing a layer of optically transparent and conductive material onto a first side of a first substrate. For example, with respect to FIG. 2B, depositing a first film can include depositing optically transparent and conductive material on a first side of the first substrate 208 to form the first layer of film 206.

In some implementations, the first film exhibits optical transmission of approximately 80% or more. For example, the first film exhibits optical transmission of approximately 90% or more.

The process 400 includes depositing a second film on a substrate (404). In some implementations, depositing the second film includes depositing a layer of optically transparent and conductive material onto a first side of a second substrate. For example, with respect to FIG. 2B, depositing a second film can include depositing optically transparent and conductive material on a first side of the second substrate 212 to form the second layer of film 210.

In some implementations, depositing the second film can include depositing a layer of optically transparent and conductive material onto a second side of the first substrate. For example, with respect to FIG. 2D, depositing a second film can include depositing optically transparent and conductive material on a second side of the first substrate 208 to form the second layer of film 210.

The process 400 optionally includes joining a bottom surface of the first substrate to a top surface of the second film (406). For example, with respect to FIG. 2B, the bottom surface of the first substrate 208 is joined to the top surface of the second layer of film 210.

In some implementations, joining a bottom surface of the first substrate to a top surface of the second film includes using an adhesive. For example, as described in more detail with respect to FIGS. 2B-2C, joining a bottom surface of the first substrate 208 to a top surface of the second film 210 includes coating the second film 210 and/or the bottom surface of the first substrate 208 in an adhesive and then stacking the first film 206 and the first substrate 208 on to the second film 210 and the second substrate 212.

In some implementations, joining a bottom surface of the first substrate to a top surface of the second film includes using a fastener. For example, as described in more detail with respect to FIGS. 2B-2C, joining a bottom surface of the first substrate 208 to a top surface of the second film 210 includes using a clamp that contacts a top surface of the first film 206 and/or the fist substrate 208 and a bottom surface of the second substrate 212.

The process 400 includes electrically coupling at least one of the first film and the second film to a transmitter, receiver, or transceiver (408). For example, with respect to FIG. 2B, only the first layer of film 206 is electrically coupled to a component. As another example, with respect to FIG. 2D, both the first layer of film 206 and the second layer of film 210 are electrical coupled to a component.

In some implementations, the process 400 includes cutting the first film and the first substrate to a desired geometry. In some implementations this is performed after the depositing a first film of an optically transparent material on a first substrate (402) but before depositing a second film on a substrate (404). For example, after the depositing a first film of an optically transparent material on a first substrate, the first film and the first substrate are cut to the desired geometry such that the width-to-length ratio of the two layer is 0.8. In some implementations this is performed after the depositing a first film of an optically transparent material on a first substrate (402) and depositing a second film on a substrate (404). As an example, after the depositing a first film of an optically transparent material on a first side of a substrate and depositing a second film on a second side of the substrate, the first film, the second film, and the substrate are cut to the desired geometry such that the width-to-length ratio of the two layer is 0.8. Cutting the first film, the first substrate, the second film, and/or any other substrate can include cutting using one or more of the following: a blade operated by a user, scissors operated by a user, a blade operated by a machine, scissors operated by a machine, a laser operated by a user or machine, etc.

Optically transparent antennas as described herein have a large number of unique and desirable applications because, for example, this type of antenna does not require much space, has a flexible form factor, and has desirable opto-electrical properties. For example, optically transparent antennas provide optical and electrical advantages and capability of integration with panels, window glass, and screens. Potential applications include security, cars, smart homes, and communication systems. Transparent conductive films (TCFs), such as Indium Tin Oxide (ITO), Carbon Nanotube (CNT), Silver Nanowire (AgNW) are considered herein as potential materials to construct a transparent antenna because these conductors can produce transmission of electric currents while retaining transparent properties.

Fabrication of transparent antennas requires an optically transparent conductor and a range of different fabrication methods are viable. Various materials like copper (Cu), ITO, AgNW have been explored and experimental results show good radiation characteristics that proves the potential of transparent antennas being used in wireless communications.

In some implementations, copper, aluminum, and/or iron are used to fabricate an optically transparent antenna. For example, one or more transparent and conductive film layers of the optically transparent antenna is made from copper, aluminum, iron, or a compound thereof.

Below is a discussion of various materials that are viable for use in constructing an optically transparent antenna and/or as one or more components of an optically transparent antenna. As an example, a film made from any of the materials discussed below is usable as the film 206 described above with respect to FIGS. 2A-2D, the film 210 described above with respect to FIGS. 2B-2D, or the film 214 described above with respect to FIG. 2C. In some implementations, each film layer is made from the same material. In some implementations, two or more film layers are made from the same material. In some implementations, each of the film layers is made from a different material.

In some implementations, Indium Tin Oxide (ITO), Carbon Nanotubes (CNTs), Silver Nanowire (AgNW) are used to fabricate an optically transparent antenna fabrication (e.g., as viable alternatives to the conductors like copper, aluminum, and iron). For example, one or more transparent and conductive film layers of the optically transparent antenna is made from ITO, CNTs, AgNW, compounds thereof, and/or a hybrid material that includes one or more of ITO, CNTs, and/or AgNW. In more detail, one or more transparent and conductive film layers of the optically transparent antenna is made from a hybrid between of AgNW and CNT.

In more detail, a new approach of combining the above mentioned materials with one another or creating ultra thin metal meshes to improve the conductivity has recently become a good area of antenna research and has expanded the scope of this thesis to explore a new kind of transparent conductor that is a hybrid between of AgNW and CNT.

In some implementations, one or more transparent and conductive film layers of the optically transparent antenna is made from a transparent conducting oxide (TCO). For example, each transparent and conductive film layer of an optically transparent antenna is made from a TCO. Example TCOs include, Indium Tin Oxide (ITO), Gallium-doped Zinc Oxide (GZO), and Aluminum-doped Zinc Oxide (AZO).

Indium Tin Oxide (ITO) is a transparent and colorless thin film that has electrical conductivity and optical transparency. Table 2.1 lists some key properties of ITO like thickness, sheet resistance, and transparency as reported in literature. The reported transparency values depend on the visible range or specific visible length used. Different visible ranges analyzed include 400-700 nm, 300-900 nm, and 400-800 nm. Some values are reported at the visible length of 550 nm. Although the reported transparencies are measured in slightly different values of the visible range, the data suggest that ITO can be considered a good transparent conducting oxide as indicated by the table below showing survey on properties of ITO.

| | Sheet | | |
|---|---|---|---|
| Thickness | Resistance | Resistivity | Transparency |
| (nm) | (Ω □) | (Ω · cm) | (%) |
| 500 | 8.50 | 4.25 × 10⁻⁶ | 95 |
| 300 | 1.07 | 3.22 × 10⁻⁷ | 77 |
| 150 | 27 | 4.05 × 10⁻⁶ | 85 |
| 78 | 230.77 | 1.80 × 10⁻⁵ | Not Reported |
| 447 | 12.60 | 5.63 × 10⁻⁶ | 87 |
| 199 | 152 | 3.03 × 10⁻⁵ | 89.1 |
| 700 | 4.29 | 3 × 10⁻⁶ | 90 |
| 100 | 20 | 2 × 10⁻⁶ | 85 |

ITO is an advantageous transparent conducting oxide. But it has some drawbacks like high cost of materials, scarcity of indium, and brittleness. The brittleness often leads to problems like the film cracking and getting electrically isolated which is not ideal for space applications. To overcome all these problems and come up with a good alternative of ITO, other materials have been explored including other TCOs like GZO and AZO.

Galium-doped Zinc Oxide (GZO) is a viable alternative to ITO because GZO thin films are capable of showing 85 to 90% optical transparency in the visible range and Galium is better than Indium in terms of cost and availability in the nature. The table below provides a brief summary of GZO properties.

| | Sheet | | |
|---|---|---|---|
| Thickness | Resistance | Resistivity | Transparency |
| (nm) | (Ω □) | (Ω · cm) | (%) |
| 150 | 19.80 | 2.97 × 10⁻⁶ | 85 |
| 200 | 34.00 | 6.80 × 10⁻⁶ | 90 |
| 350 | 142.86 | 5.00 × 10⁻⁵ | 85 |
| 603 | 28.19 | 1.70 × 10⁻⁵ | 87.3 |
| 449.89 | 18.76 | 8.44 × 10⁻⁶ | 93.58 |
| 450.12 | 16.84 | 7.58 × 10⁻⁶ | 92.88 |
| 100 | 120 | 1.20 × 10⁻⁵ | 92 |

Transparency of GZO films for various film thickness is comparable to ITO film transparencies. GZO films have been deposited on glass, PET substrates and their transparencies have been reported in different ranges of visible spectrum as researchers have recorded the transparency of GZO films in −00-800 nm, 600-900 nm, 535 nm, 550 nm, and −80-780 nm.

Aluminum-doped Zinc Oxide or AZO is another viable option for constructing TCFs and, therefore, optically transparent antennas as nature has abundant supply of Aluminum which eventually can cut down the cost of producing TCOs and help reduce the use of the scarce materials like Indium or even Gallium. The table below contains categorized overview of properties of AZO as a transparent conducting oxide which indicates AZO can be used as a viable option for preparing TCFs and its transparency is comparable to ITO and GZO in the visible region of 400-900 nm and 400-800 nm.

| | Sheet | | |
|---|---|---|---|
| Thickness | Resistance | Resistivity | Transparency |
| (nm) | (Ω □) | (Ω · cm) | (%) |
| 100 | 37.50 | 3.8 × 10⁻⁶ | 92 |
| 500 | 7.1 | 3.5 × 10⁻⁶ | 90 |
| 341 | 9 | 3.07 × 10⁻⁶ | 85.1 |
| 300 | 29.30 | 8.79 × 10⁻⁶ | 90 |
| 600 | 3.75 | 2.25 × 10⁻⁶ | 86 |

GZO and AZO have emerged as potential competitors of ITO having comparable transparency in the visible region. Moreover, GZO and AZO can be used to overcome common drawbacks of ITO such as brittleness and low availability of material.

Carbon Nano-tube (CNT) is a carbon-based transparent conductor. CNTs have been studied due to their electrical conductivity, mechanical flexibility and stability, as well as their optical transparency. CNTs can be considered as a rolled graphene sheet and are classified according to the number of rolls: Single Wall Carbon Nanotube (SWCNT); and Multi Wall Carbon Nanotube (MWCNT). The table below displays a brief overview of the recent works which have been carried out on the electro-optical properties of CNT films. Usually, transparent conducting films are characterized by the film thickness; but in case of CNT, researchers often report the diameter as a method of characterization. As it is shown in the table below, diameter of the SWCNT under investigation is described instead of film thickness.

| | Sheet | | |
|---|---|---|---|
| Thickness | Resistance | Resistivity | Transparency |
| (nm) | (Ω □) | (Ω · cm) | (%) |
| 1.9 | 220 | Not Reported | 84 |
| 130 | 169.76 | 2.21 × 10⁻⁵ | 58.3 |
| 50 | 30 | 1.5 × 10⁻⁶ | 70 |
| 100 | 69.93 | 6.99 × 10⁻⁶ | Not Reported |

CNT films are reported capable of exhibiting optical transparency ranging from 83.4% to 90% and sheet resistance ranging from 24 to 208Ω□. These values vary depending on how the CNT film has been deposited or prepared. A very thin sheet of carbon is recognized as graphene and it also has the potential to be used as a transparent conducting film or TCF because of the thin nature and good electrical properties. A 100 m long graphene TCF is reported to have a sheet resistance of 150Ω□. Graphene transparent conducting films can show 80% and 90% of optical transparency with sheet resistance values of 280 and 350Ω□, respectively.

Silver Nanowire (AgNW) has some advantages like flexibility, surface flatness, and good enough opto-electrical properties which have made AgNW a good candidate as a TCF and/or for application in optically transparent antennas. In some implementations, AgNW networks have wire diameters of 45-110 nm with an average transparency up to 91% and a sheet resistance as low as 6.5Ω□. In one case, AgNW has been observed to have sheet resistance of 37.6Ω□ at 89.8% transparency. AgNW films have some drawbacks as well. These films tend to get oxidized very easily when exposed to air and water, leading to a sharp increase of the sheet resistance and decrease in the transparency.

In some implementations, metal networks like Copper-AgNW reduce the sheet resistance to 18.6Ω□ while retaining 88.4% transparency and, therefore, are also viable as a film for an optically transparent antenna. In some implementations, Aluminum-doped Zinc Oxide (AZO)-AgNW-Aluminum-doped Zinc Oxide (AZO) structure has a transparency of 79.9% with a lower sheet resistance of 6.2Ω□ only and, therefore, is also viable as a film for an optically transparent antenna.

In some implementations, a monopole antenna made from ITO can be used at a frequency of 3.9 GHz while maintaining a 88% transparency. The efficiency of the antenna increases from 58% to 66% if the material is a mesh between ITO and AgNW.

In some implementations, highly transparent ITO material (e.g., exhibiting optical transmission greater than 90%) is used to develop antennas that operate from 4 MHz to 13 GHz but yield very low amount of gain ranging from −6.9 dB to 2 dB. Silver Nanowire (AgNW) helps to address some issues with ITO in that the high conductivity of silver makes AgNWs suitable candidates for antennas that yield higher gain than most other transparent antennas. AgNW also is usable in very high frequency range(s) which is not the case for ITO. As an example, an AgNW antenna is designed to work in 18-40 GHz range with a 0.8 dB gain at 30 GHz. As another example, an AgNW antenna is designed to work at 61 GHz with 3.7 dB gain.

In some implementations, using one transparent conductor with another transparent conductor or using one transparent conductor with another highly conductive metal can increase the overall conductivity of the transparent film and enables the design of an efficient transparent antenna.

Silver Nano-wire (AgNW) and newly developed Nano-C Hybrid have been studied in terms of their shelf life. The study is carried out on two sets of AgNW and Nano-C Hybrid samples developed two years apart. Properties of the samples under investigation has been listed in the table below.

| | | Sheet | |
|---|---|---|---|
| Production | | Resistance | |
| Date | Sample | (Ω □) | Transparency |
| December | AgNW | 13 | 92.9% |
| 2020 | Nano-C Hybrid | 13 | 89.3% |
| March | AgNW | 12.7 | 93.5% |
| 2022 | Nano-C Hybrid | 10.6 | 87.6% |

The samples are mostly exposed to air as they are kept in the lab in the plastic envelopes in which they were shipped. The envelopes are opened to get access to the samples in order to perform tests. But the unused portion of the samples have always been kept inside the plastic envelopes and away from any physical touch of human hands or dust.

The investigation suggests that the resistance of the samples increases marginally with time. This increase in resistance is higher in case of AgNW. There are two probable causes of this phenomenon. First, the samples have aged over time and aging is prominent in AgNW than Nano-C Hybrid. Second cause would be the handling of the films as the conductive layer is very thin and is easily disturbed as it comes in contact with any other surface like human hands.

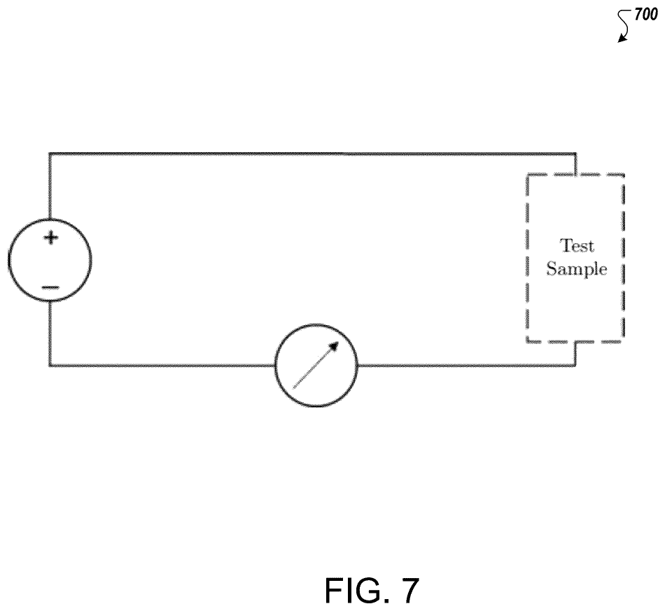

FIG. 5 is an exemplary graph 500 of a frequency response comparison between new and old silver nanowire-based antenna. The RF frequency response (S₁₁) response of the antennas made from the AgNW film suggests that the samples which are shipped at a later date have better response in high frequency (10 GHz) than the samples shipped before that. In case of the Nano-C Hybrid (e.g., hybrid material formed from AgNW and carbon nanotubes), the response of the new sample and the older sample are comparable. This observation indicates that the newly developed Nano-C Hybrid can retain its capabilities of performing in the RF frequency range for a substantial amount of time after its production. On the contrary, AgNW films loose some of their capabilities over time as can be seen in FIG. 5.

In the example of FIG. 5, antenna made with the new AgNW sample has slightly better Sn response than the antenna made from the old AgNW sample in spite of having almost identical sheet resistance as listed in the preceding table. On the other hand, the new Nano-C Hybrid has slightly lower sheet resistance than the old ones and their RF performance is also indicative of that even after being almost two and half years apart in terms of production.

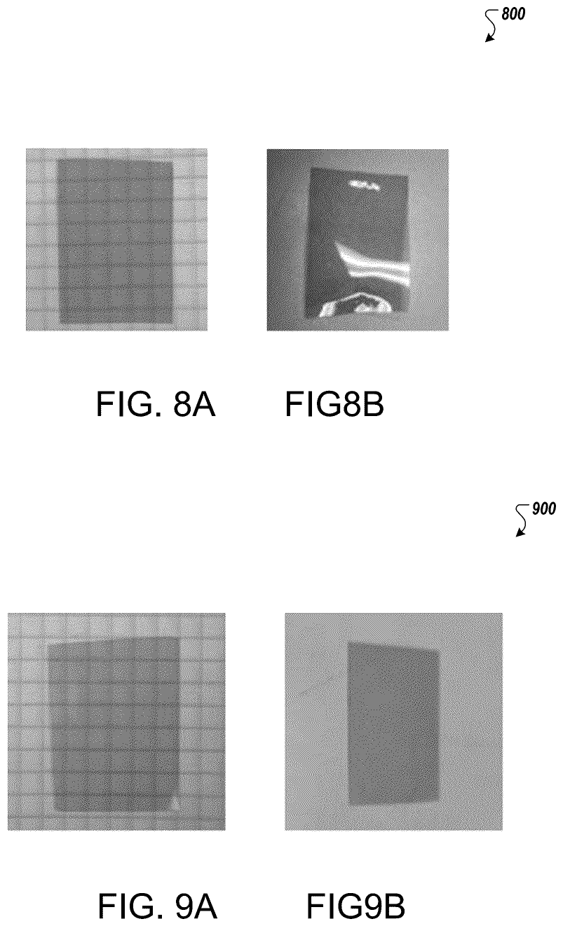

FIG. 6 is an exemplary graph 600 of a frequency response comparison between new and old hybrid-based antenna. In more detail, FIG. 6 shows the response of new and old Nano-C Hybrid-based antenna (e.g., having one or more films constructed from hybrid material made from AgNW and carbon nanotubes). The investigative results suggest, the antenna made from AgNW antenna shows tendency of reduced performance whereas the Nano-C Hybrid antenna does not. This indicates, Nano-C Hybrid films are more capable of retaining their properties for a longer period of time than AgNW films.

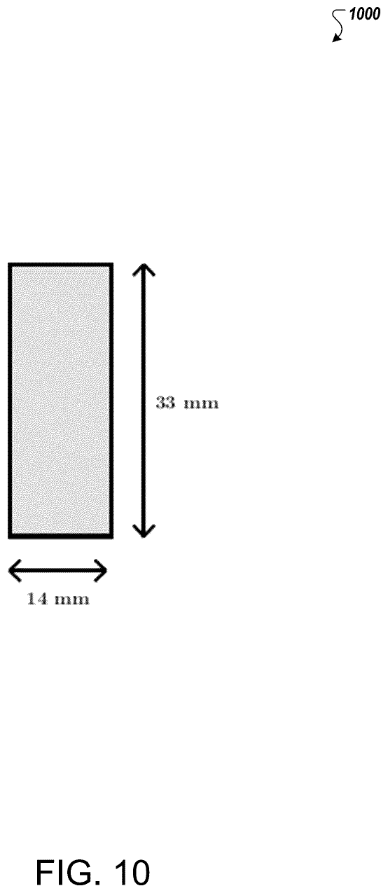

FIG. 7 shows an exemplary schematic 700 for a DC power test setup. The new samples of AgNW and Nano-C Hybrid have been tested under DC conditions to find out how much DC power can pass through them before they start to burn out. It has been observed that Nano-C Hybrid can handle slightly more power than AgNW. The surface current density (JS) is measured along the width of the tested samples and the measurement suggests that AgNW samples break down at a lower surface current density than the Nano-C Hybrid samples. The test has been conducted with different sizes of the samples by cutting the samples by half both in length and width in each iteration. This is done to measure the maximum power at the breakdown point for different sample sizes. The size chart is shown in the table below is a sample size index for the DC power test.

| | | |
|---|---|---|
| Size 1 | Length | 36.5 mm |
| | Width | 28.5 mm |
| Size 2 | Length | 18.4 mm |
| | Width | 14.5 mm |
| Size 3 | Length | 9.4 mm |
| | Width | 7.5 mm |

The table below related to DC power handling contains the results of the investigation conducted with samples of different sizes as listed in the table above. It has been observed that reducing the size of the samples into quarter size of the previous sample does not affect the measured resistance but clearly indicates the decline in maximum power handling capacity for both Nano-C Hybrid and AgNW. The breakdown power for Nano-C Hybrid is higher than AgNW irrespective of the sample size. This proves Nano-C Hybrid can handle more power in DC than AgNW films, which is a clear indication that significant improvement can be made in terms of DC power conduction by combining carbon nanotubes and silver nanowire rather than using standalone AgNW transparent conductive films. The data suggest that Nano-C Hybrid breaks down at a higher amount of DC voltage than AgNW of the same size. The surface current density (JS) for different sample size remains in close proximity with each other for both Nano-C Hybrid and AgNW.

| | | | | Resis- | | |
|---|---|---|---|---|---|---|
| Size | | Voltage, | Current, | tance, | Power, | JS |
| Index | Sample | V (V) | I (A) | R (Ω) | P (mW) | (A/m) |
| 1 | Nano-C Hybrid | 8 | 0.308 | 25.97 | 2464 | 11.49 |
| | AgNW | 5 | 0.161 | 31.06 | 895 | 5.77 |
| 2 | Nano-C Hybrid | 6 | 0.221 | 27.15 | 1326 | 15.03 |
| | AgNW | 4 | 0.122 | 32.79 | 488 | 8.55 |
| 3 | Nano-C Hybrid | 4 | 0.159 | 25.16 | 636 | 21.20 |
| | AgNW | 3 | 0.090 | 33.33 | 270 | 12.07 |

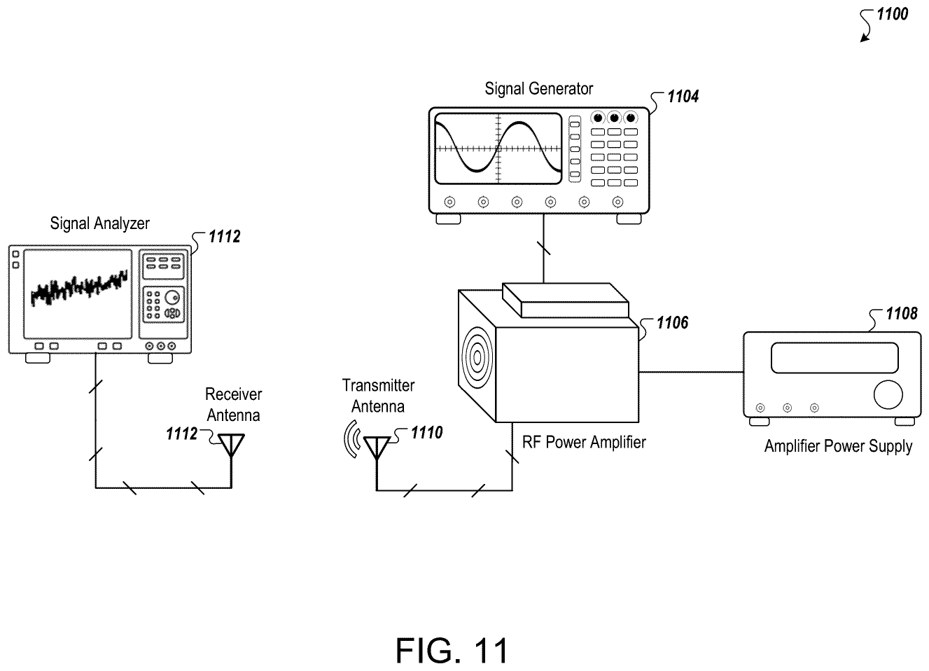

FIGS. 8A-8B show exemplary optically transparent material and effects of DC power on the material. FIG. 8A shows the Nano-C hybrid material 800a before the DC power is applied. FIG. 8B shows the Nano-C hybrid material 800b after DC power is applied. While conducting the DC power test, it has been observed that Nano-C Hybrid experiences slight deformation like bending when exposed to a high voltage. FIGS. 8A-8B show the deformation of the Nano-C Hybrid sample (Size Index 1) after the DC power handling test has been conducted.

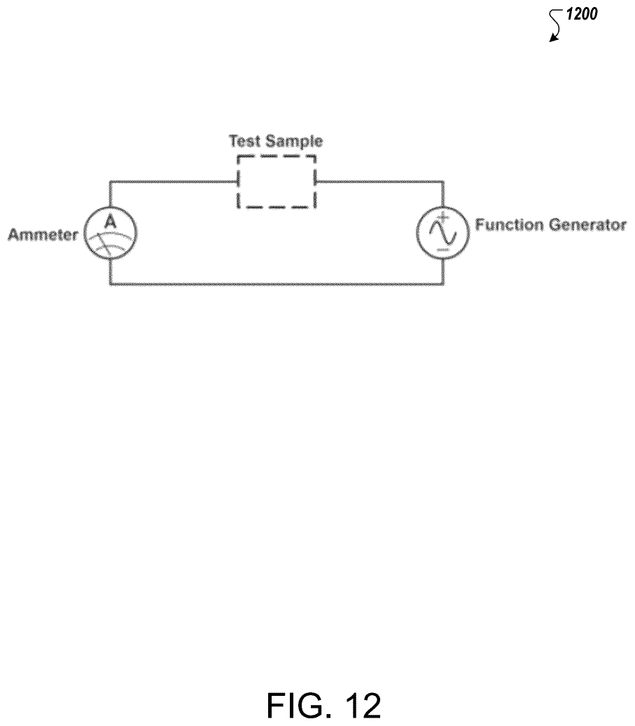

FIGS. 9A-9B show exemplary optically transparent material 900a-900b and effects of DC power on the material. FIG. 9A shows the silver nanowire (AgNW) material 900a before the DC power is applied. FIG. 9B shows the silver nanowire (AgNW) material 900b after DC power is applied. The AgNW sample of the same size does not exhibit any kind of deformation even after being exposed to the maximum voltage it can handle. FIGS. 9A-9B show that AgNW sample have no sort of deformity after begin exposed to high voltage.

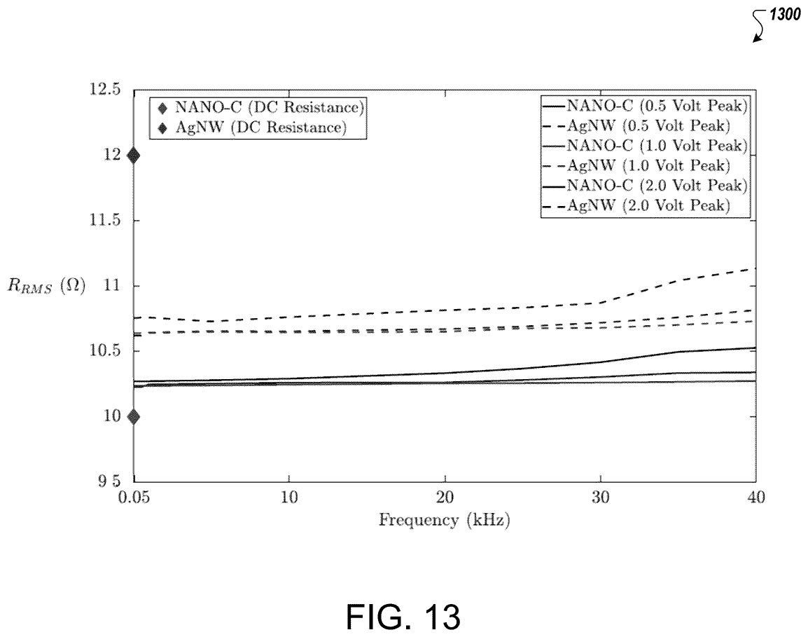

FIG. 10 shows an exemplary schematic 1000 of a sample for a radiofrequency (RF) power test. The example schematic 1000 shows a sample having a width of approximately 14 mm and a length of approximately 33 mm, making the width-to-length ratio 0.42. The Nano-C Hybrid and AgNW films have been tested to study the breakdown point of the respective films when RF power is used. The test has been conducted at 2 GHz.

In order to conduct the RF power handling test, the antennas made from the two transparent conductive films under investigation are needed to be fed by high input power. Typically, the antennas can radiate with an input power of as low as −5 dBm and in order to find out the highest amount of RF power the antennas can handle, the input power needs to be amplified. That is why a very high power RF amplifier has been used to conduct this particular test. The equipment used for this test is listed below: E4433B ESG-D Series Digital RF Signal Generator; N9000A CXA Signal Analyzer; and ZHL-30 W-252-S+ High Power Amplifier.

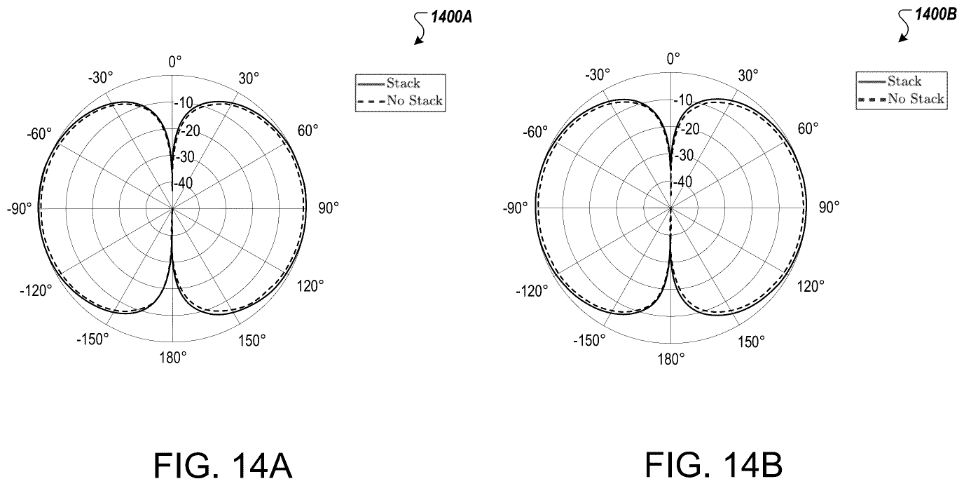

FIG. 11 shows an example of a system 1100 for testing an optically transparent antenna. In testing, the transparent antenna is placed on the fixture. The system 1100 includes an optically transparent transmitter antenna 1112, a receiver antenna 1112 (e.g., an optically transparent antenna or a different type of antenna), an amplifier power supply 1108, a radiofrequency (RF) power amplifier 1106, a signal generator 1104, and a signal analyzer 1102. The fixture is connected to the power amplifier which is fed by the signal generator. This antenna is the transmitting antenna. Another antenna made from copper tape with the same dimension is placed on another fixture and is connected to the signal analyzer so that it works as the receiver.

In the example system 1100 for testing, the distance between the transmitter and the receiver is approximately 29 cm. The transmitter antenna 1112 is being fed by the amplified input power and the signal analyzer 1102 is being used to observe how much power is received by the receiver antenna 1112. The RF amplifier 1106 has 50 dB of typical gain at 2 GHz so the starting input power from the signal generator is taken very low at −31 dBm and then it was increased gradually to see how much RF power the transmitter antenna 1112 can handle.

The radiofrequency (RF) power test shows the Nano-C Hybrid based monopole starts to radiate less power when the input power to the antenna is 42 dBm or approximately 16 W. On the other hand, the antenna made from AgNW breaks down at 39 dBm or approximately 8 W of input power. The test results are in line with the DC power test which suggested that Nano-C Hybrid can handle more power than AgNW. Also, just like with DC power, the Nano-C Hybrid based antenna experiences slight deformity with high RF power whereas AgNW based antenna does not. The DC power test conducted with AgNW sample showed no signs of deformity after exposing the samples to high DC power. However, the DC resistance of the AgNW sample became 10 MΩ after the exposure, which is substantially higher than the typical DC resistance and also comparatively higher than the resistance of the Nano-C Hybrid films of the same size. The test results indicate that the Nano-C Hybrid films can conduct and handle more DC and RF power than AgNW films.

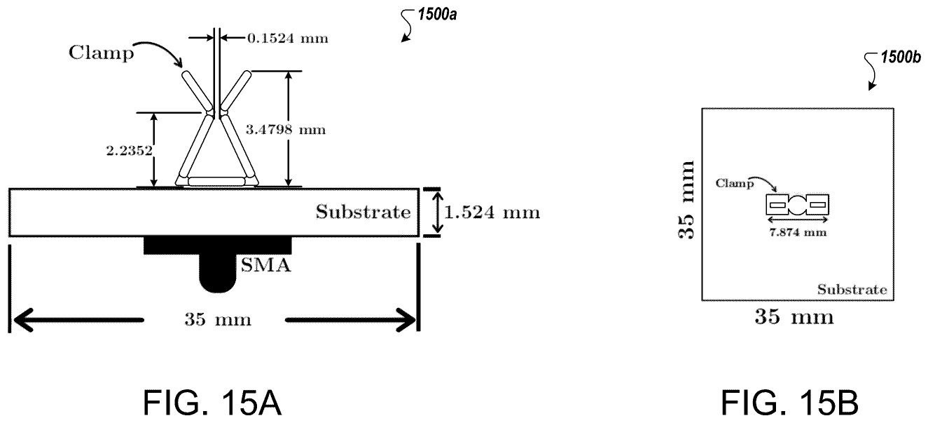

FIG. 12 shows an exemplary circuit diagram 1200 for an AC power test setup. The Nano-C Hybrid and AgNW films have been tested under AC power to determine if the impedance changes with respect to frequency and to see how they behave when fed with AC power. The test setup is shown in FIG. 12, where the samples are connected to the function generator and the multimeter. The input voltage and frequency in the function generator have been changed and the AC current has been noted from the multimeter at each step. The samples used for this investigation are 10 mm long and 7.5 mm wide. The first thing done after the samples are prepared is to measure the DC resistance before exposing them to AC power. The initial DC resistance of the samples have been listed in the table below.

| | Measured DC |
|---|---|
| | Resistance, |
| Sample | Rₘₑₐₛ, (Ω) |
| Nano-C | 10 |
| Hybrid | |
| AgNW | 12 |

This particular test has been conducted with 0.5 V, 1.0 V, and 2.0 V of input peak voltage of the function generator and the frequency ranges from 50 Hz to 40 kHz.

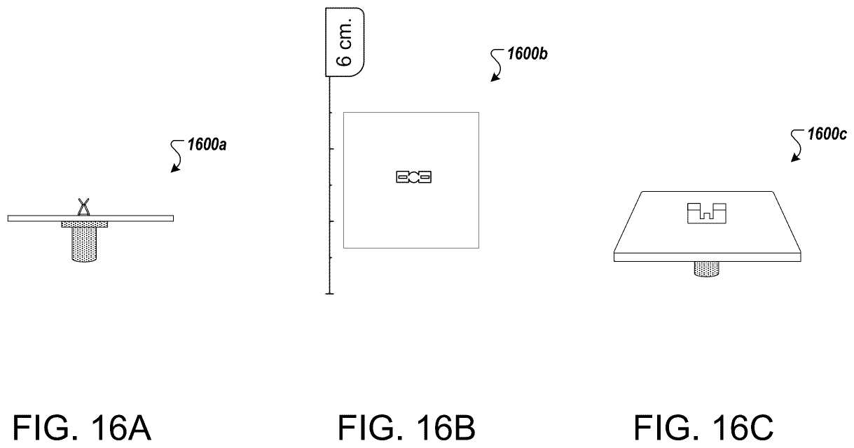

FIG. 13 is an exemplary graph 1300 showing the alternating current (AC) impedance characteristics for different optically transparent materials. In the example of FIG. 13, the graph 1300 shows that the AC impedance remains very close to the DC measured impedance both for Nano-C Hybrid and AgNW at low frequency. This can be said in case of a lower frequency range, but it would have been better if it was possible to see the response in higher frequency range as well. The Tektronix CDM250 Digital Multimeter only works within this lower range of frequency and the function generator used for this test cannot go beyond 40 kHz. This leaves a scope of conducting research on these particular characteristics in the future, but for now, the graph 1300 suggests the impedance of both Nano-C Hybrid and AgNW remain very close to the measured DC resistance as the frequency gradually rises. From this observation, it can be assumed that, the impedance will not dramatically increase and make the transparent conducting films unusable when the frequency is much higher.

Under the test conditions, it has been observed that both the Nano-C Hybrid and AgNW can withstand up to 10 V of peak voltage from the function generator and handle 4100 mW of power on average. This amount of voltage and power is significantly higher than the DC burn out voltage (4 V for Nano-C Hybrid and 3 V for AgNW) and power (636 mW for Nano-C Hybrid and 270 mW for AgNW) as shown in the DC power handling table below. This is an interesting observation that indicates, the samples might possess some material characteristics that allow them to withstand more power in AC than in DC.

| | | | | Resis- | | |
|---|---|---|---|---|---|---|
| Size | | Voltage, | Current, | tance, | Power, | JS |
| Index | Sample | V (V) | I (A) | R (Ω) | P (mW) | (A/m) |
| 1 | Nano-C Hybrid | 8 | 0.308 | 25.97 | 2464 | 11.49 |
| | AgNW | 5 | 0.161 | 31.06 | 895 | 5.77 |
| 2 | Nano-C Hybrid | 6 | 0.221 | 27.15 | 1326 | 15.03 |
| | AgNW | 4 | 0.122 | 32.79 | 488 | 8.55 |
| 3 | Nano-C Hybrid | 4 | 0.159 | 25.16 | 636 | 21.20 |
| | AgNW | 3 | 0.090 | 33.33 | 270 | 12.07 |

Typically, the word “antenna” refers to some metallic device (as a rod or wire) which can be used for radiating or receiving radio waves. Antennas can be made from different materials and substrates based on the characteristics that affect the performance of antenna. Of note, optically transparent antennas are desirable due to the possible advantages and capabilities of integration with panels, window glass, and screens. Potential applications of optically transparent antennas include security, cars, smart homes, and various communication devices such as smart phones. Transparent and electrically conductive materials include oxides of tin, indium, zinc, and cadmium, and metals such as silver. Usability of a transparent conductor can be determined from sheet resistance, and the thickness of the transparent conductive film (TCF). The sheet resistance, R_{S}, and thickness, t are related to each other as characterized by the following equation: R_{S}=1/(σt) (Ω□), where σ is the electrical conductivity and t is the film thickness.

Since the thickness t of the transparent conductor is usually very thin in order to maintain a high optical transparency, an important measure is to compare the conductor thickness with the microwave skin depth δ, which is computed from the following equation: δ=1/(√(πfμσ)), where f is the operational frequency and p is the permeability.

The optical transparency T can be characterized in terms of film thickness t as shown in the following equation: T=e^{-kt}, where k is a constant related to material properties such as electron mobility. Lower film thickness would yield higher transparency but with higher sheet resistance which means the conductivity would be lower. This indicates a need of proper trade-off between the film thickness and the conductivity requirement to produce a good working TCF which can be implemented in antenna design.

The sheet resistance, R_{S} and the film thickness t can be utilized to estimate the resistance of the TCF. Normally, resistance R is calculated using the following equation: R=μL/A (Ω□), where is resistivity of the sample, L is sample length and A is the cross-sectional area of the sample which can be expressed as A=Wt where W is the width of the sample. Accordingly, this equation can be re-written as follows: R=(μL)/(tW) (Ω).

Using this last equation and the equation for calculating sheet resistance R_{S} described above, the following equation is obtained: R=R_{S} (L/W) (Ω). This equation establishes a relationship between sheet resistance and the dimension of the sample. It is clear that the resistance of the TCF will vary based on its sheet resistance and also the length and width of the sample under investigation. From this equation, the width-to-length ratio of the sample plays a vital role in determining the resistance and it has been observed with numerous iterations and simulations in this research that. As an example, a width-to-length ratio of 0.8 was determined to be an optimum ratio (however, other ratios are possible and may provide other benefits).

With respect to gain improvement, the thickness of the conductive layer in TCFs under investigation is very low in order to make the films transparent. Although, the actual conductive layer thickness in Nano-C Hybrid and AgNW has not been reported by the manufacturing company, for the purpose of this thesis, the thickness has been assumed to be 20 nm. Using this thickness and the sheet resistance of the films, the resistance and conductivity of a particular sample can be estimated. If the gain of the antennas made with Nano-C Hybrid and AgNW TCFs is initially lower, simulation and experimental results suggest there are at least two ways to improve the gain.

The length for each monopole antenna has been calculated to be equal to the quarterwave length of the respective resonant frequency and the width has been selected such that the width-to-length ratio is fixed at the example optimum value of 0.8 as shown in the table below showing standard length and width for monopole antenna design.

| Frequency | Length | Width | Width- |
|---|---|---|---|
| f | L | W | to-Length |
| (GHz) | (mm) | (mm) | Ratio |
| 2 | 37.5 | 30 | 0.8 |
| 3.75 | 20 | 16 | 0.8 |
| 5 | 15 | 12 | 0.8 |

From this table, an example 2 GHz monopole antenna is 37.5 mm long and 30 mm wide. Simulation results have shown that, if the width is increased in such a way that it retains the optimum ratio with the length, the resonant frequency does not get affected significantly. This opens up a possibility to test the antenna gain by changing the width. Simulation results have proved that, the gain actually increases marginally if the width of the antenna is increased.

Table below shows results of a widening test. In more detail, the tables shows that the gain of an example 2 GHz monopole antenna, both Nano-C Hybrid and AgNW based, exhibits approximately 0.3 dB increased gain if the width of the antenna is doubled.

| | Gain (dB) | | |
|---|---|---|---|
| | Before Widening | After Widening | Gain |
| Antenna | (W-to-L ratio | (W-to-L ratio | Increase |
| Material | of 0.4 | of 0.8) | (dB) |
| Nano-C | −1.21 | −0.87 | 0.34 |
| Hybrid | | | |
| AgNW | −1.54 | −1.23 | 0.31 |

From simulation data, the gain of the example antenna made from a transparent conductive film can be improved by increasing the width of the antenna keeping in mind that the width does not exceed the length in order to keep the resonant frequency intact. This means, it is necessary to maintain the optimum width-to-length ratio.

Stacking two samples on top of another helps increase the gain of the fabricated antenna. Simulation results for an example 2 GHz monopole antenna have been listed in the table below.

| | Gain (dB) | | |
|---|---|---|---|
| | Without Stacking | With Stacking | Gain |
| Antenna | (W-to-L ratio | (W-to-L ratio | Increase |
| Material | of 0.8) | of 0.8) | (dB) |
| Nano-C | −0.88 | 0.06 | 0.82 |
| Hybrid | | | |
| AgNW | −1.26 | −0.16 | 1.1 |

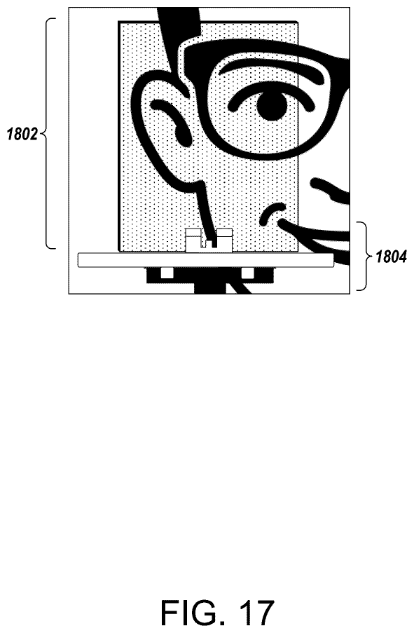

FIGS. 14A-14B shows exemplary graphs 1400a-1400b showing simulated radiation patterns for different optically transparent materials. The example simulated radiation pattern depicted in the graph 1400a of FIG. 14A confirms that antenna gain can be increased by using more than one samples for a 2 GHz Nano-C Hybrid antenna. The example simulated radiation patterns depicted in the graph 1400a of FIG. 14A confirms that antenna gain can be increased by using more than one samples for a 2 GHz AgNW antenna.

In the FIGS. 14A-14B, it is seen that, for both Nano-C Hybrid and AgNW based antennas, the gain increases at least 0.8 dB if two samples have been stacked together. In these simulations, the width-to-length ratio is the example optimum value of 0.8.

The transparent conductive films used to design antennas are rectangular and hence the fabricated transparent monopole antennas are also rectangular. The length of the monopoles are quarter-wavelength and the width is decided using the example optimum the width-to-length ratio of 0.8. In order to feed the antennas, a test fixture has been designed using the Rogers RO4003 substrate. The substrate has copper cladding on the top and the bottom side. The top copper cladding has been rubbed off using an LPKF S103 Milling Machine while keeping the copper cladding of the other side of the substrate intact. The board works as a ground plane for the antennas. The attributes of the test fixture are listed in the table below.

| Material | Rogers RO4003 |
|---|---|
| ϵᵣ | 3.55 |
| Dimension | Length: 35 mm |
| | Width: 35 mm |
| | Height: 1.524 mm |

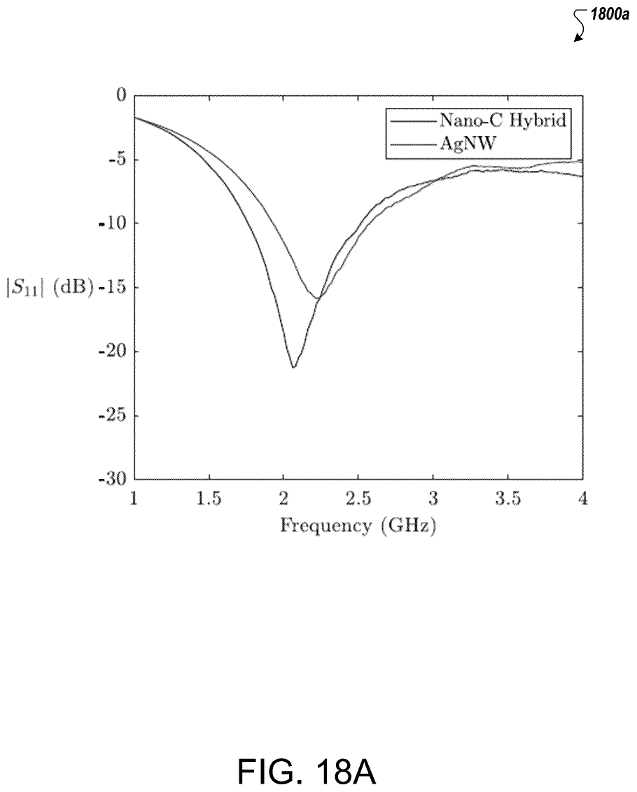

FIGS. 15A-15B show exemplary schematics 1500a-1500b for a test fixture for testing an optically transparent antenna. FIG. 15A shows a side view of an example schematic 1500a for a test fixture for testing an optically transparent antenna. FIG. 15B shows a top view of an example schematic 1500b for a test fixture for testing an optically transparent antenna. A clamp made from 0.2 mm thick Pre-Tin Plated Phosphorus Bronze is placed on one side of the fixture to secure the test samples firmly on the fixtures and to properly feed the antennas. FIGS. 15A-15B shows the schematics 1500a-1500b of the test fixture which has been used throughout the experiments conducted.

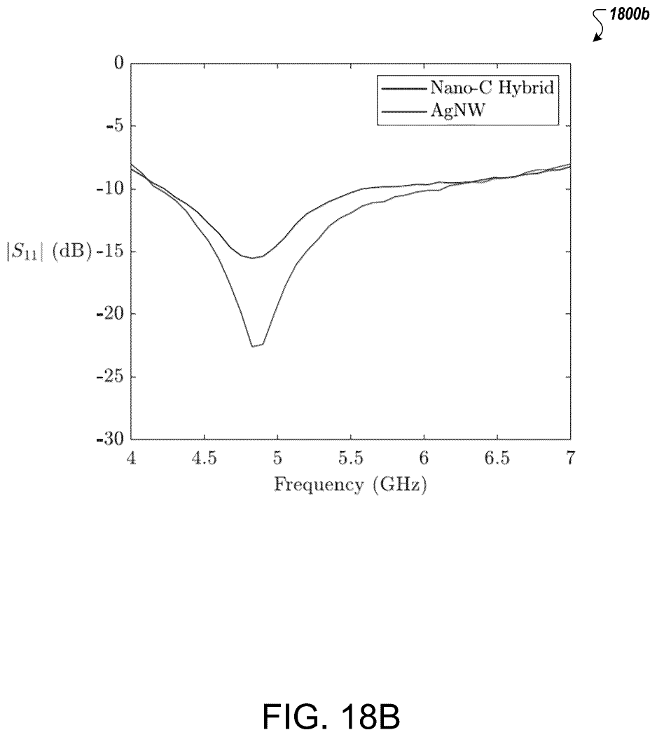

FIGS. 16A-16C show exemplary test fixtures 1600a-1600c for testing an optically transparent antenna. FIG. 16A shows a side view of an example test fixture 1600a for testing an optically transparent antenna. FIG. 16B shows a top view of an example test fixture 1600b for testing an optically transparent antenna. FIG. 16C shows a front view of an example test fixture 1600a for testing an optically transparent antenna.

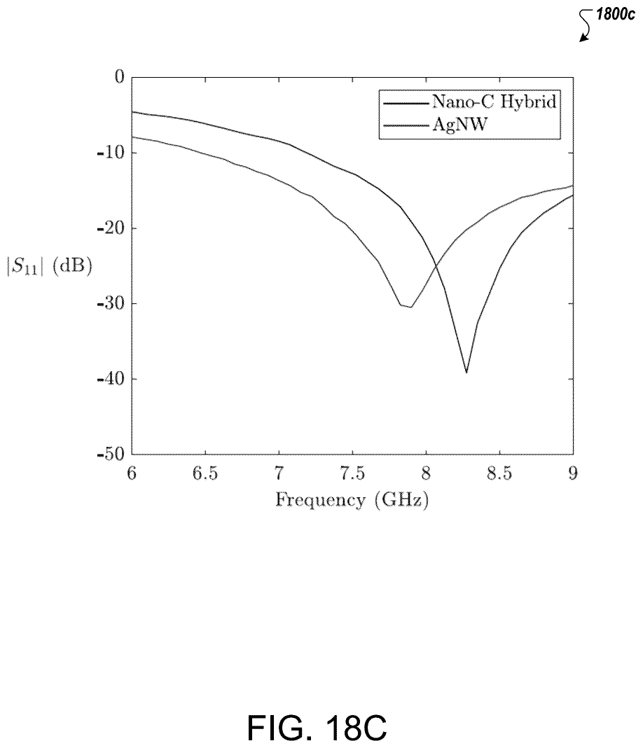

FIG. 17 shows an exemplary optically transparent antenna 1802 mounted to a test fixture 1804. The SMA connector is used to connect the fixture to the vector network analyzer to observe and record the reflection co-efficient (S11) of the antenna at different frequencies. FIG. 17 shows how the optically transparent antenna 1802 (e.g., film and substrate layers) are placed inside the clamps to securely place the samples on the fixture 1804 and perform measurements.

The N5225A PNA Microwave Network Analyzer has been used in the test setup for S₁₁ measurements. In case of gain measurements, following equipment have been used to set up the test environment: E4433B ESG-D Series Digital RF Signal Generator; and N9000A CXA Signal Analyzer.

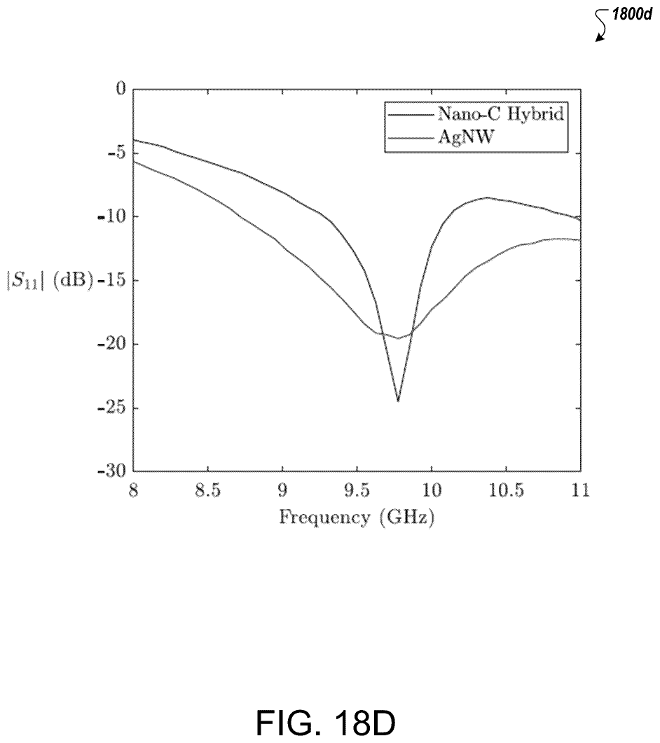

FIGS. 18A-18D shows exemplary graphs 1800a-1800d depicting an optically transparent antenna response at different frequencies. FIG. 18A shows an example graph 1800a depicting an optically transparent antenna response at 2 GHz. FIG. 18B shows an example graph 1800a depicting an optically transparent antenna response at 5 GHz. FIG. 18C shows an example graph 1800a depicting an optically transparent antenna response at 8 GHz. FIG. 18A shows an example graph 1800a depicting an optically transparent antenna response at 10 GHz. First set of experiments have been performed to observe the response of the antennas made from Nano-C Hybrid and AgNW at different frequencies. Investigation results clearly suggests that both TCFs can be used to design antennas which can operate in a wide range of frequencies. The Sn vs frequency plot of the graph 1800a shown in FIG. 18A suggests Nano-C Hybrid and AgNW can be used to design 2 GHz antennas.

Experiments conclude that the samples can actually be used to design antennas which are able to radiate at 2, 5, 8, and 10 GHz. FIGS. 18B-18D show example Nano-C Hybrid and AgNW based monopole antennas work at 5 GHz, 8 GHz, and 10 GHz, respectively. The monopole antennas have been mounted on the fixtures using the clamps and it has been made sure that the antenna samples sit firmly onto the fixtures and there is no other radiating element nearby where these measurements have been performed. After considering all these facts, the measurement results for the 2 GHz, 5 GHz, 8 GHz, and 10 GHz antennas indicate that the transparent conductive films are capable of working as high frequency antenna materials. Overall, the frequency response of the antennas made from transparent conducting films is clear evidence of them being effective antenna design materials.

Relative gain measurements have been carried out for the antennas made from Nano-C Hybrid and AgNW. One of the antennas is fed with a power PT by the E4433B ESG-D Series Digital RF Signal Generator and the other antenna is placed at a distance D, more than the far field distance of the transmitting antenna, and is connected to N9000A CXA Signal Analyzer to record how much power PR is being received by the receiver antenna.

Friis transmission equation in log scale is utilized in this part of the experiments which is shown in the following equation: P_{R}=P_{T}+G_{R}+G_{R}+20 log₁₀ (λ/(4πD)) (dB). The symbols are as follows: P_{R}=received power; P_{T}=transmitted power; G_{R}=receiver antenna gain; G_{T}=transmitter antenna gain; λ=wavelength; D=distance between transmitter and receiver. For the copper tape-based antennas, as they are identical, it has been assumed that, their gain is approximately the same which means G_{R}=G_{R}. Using this assumption, the gain of the copper tape antennas at different frequencies have been measured using the preceding equation and recorded in the table below.

| Frequency | Gain |
|---|---|
| (GHz) | (dB) |
| 2 | 1.66 |
| 3.75 | 1.64 |
| 5 | 1.61 |

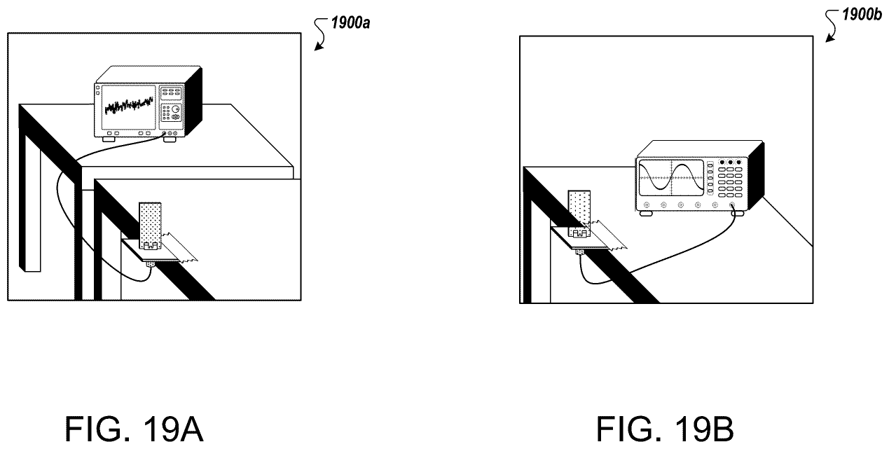

FIGS. 19A-19B show exemplary antennas 1900a-1900b. FIG. 19A shows an example copper tape antenna 1900a that has been placed at the receiver end so that it can be used as a receiver antenna. FIG. 19B shows an example transparent antenna 1900b under test that has been placed at the transmitting end. For each frequency, the receiver antenna gain (G_{R}) is known from the table above which is then used in the preceding equation to calculate the transmitting transparent antenna gain.

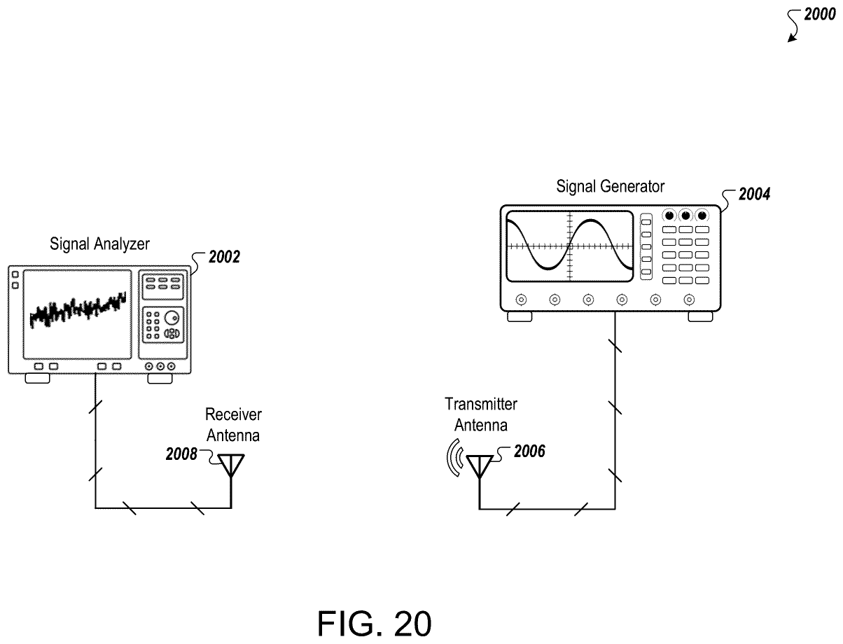

FIG. 20 shows an example of a test system 2000 for testing an optically transparent antenna. The system 2000 includes an optically transparent transmitter antenna 2008, a receiver antenna 2006 (e.g., an optically transparent antenna or a different type of antenna), a signal generator 2004 electrically connected to the transmitter antenna 2006, and a signal analyzer 2002 electrically connected to the receiver antenna 2008.

In the example of FIG. 20, the transmitter and the receiver antenna have been placed at a distance of D=48.7 inches or 1.24 meters. Nano-C Hybrid based antennas of 2 GHz, 3.75 GHz, and 5 GHz have been used for gain measurement and the measurement results have been listed in the following table showing the average measured antenna gain.

| | Measured | |
|---|---|---|
| Frequency | Average | L/W |
| (GHz) | Gain (dB) | Ratio |
| 2 | −2.79 | 1.25 |
| 3.75 | −3.45 | 1.25 |
| 5 | −3.02 | 1.25 |

The gain measurements have been performed three times and then the average gain value has been recorded. For the values shown in the above table, the antenna dimension has been determined by using the example optimum width-to-length ratio of 0.8.

As discussed above, the gain of the transparent antennas can be improved by widening the samples under test and by stacking more than one samples together on the test fixture. Experimental data proves that these two actions indeed improve the gain of the antenna.

The table below shows the average measured antenna gain during a widening test. In more detail, the table shows gain values of Nano-C Hybrid sample-based antenna before and after the width of the samples has been doubled.

| | Measured Average Gain (dB) | | |
|---|---|---|---|
| | Before Widening | After Widening | Gain |
| Frequency | (W-to-L ratio | (W-to-L ratio | Improvement |
| (GHz) | is 0.4) | is 0.8) | (dB) |
| 2 | −3.39 | −2.79 | 0.6 |
| 3.75 | −4.19 | −3.45 | 0.74 |
| 5 | −3.82 | −3.02 | 0.8 |

The table shows the average measured antenna gain during a stacking test. In more detail, the table shows that the gain improves by at least 0.7 dB when two Nano-C Hybrid samples are stacked together on the test fixture. The width-to-length ratio for this stacking test has been kept at the example optimum value of 0.8.

| | Measured Average Gain (dB) | | |
|---|---|---|---|
| | Before Stacking | After Stacking | Gain |
| Frequency | W-to-L ratio | (W-to-L ratio | Improvement |
| (GHz) | is 0.8) | is 0.8) | (dB) |
| 3.75 | −3.45 | −2.75 | 0.7 |
| 5 | −3.02 | −2.21 | 0.81 |

In summary, these experimental data are evidence that when TCFs are used to construct a monopole antenna, the gain of that particular antenna can be tuned and improved by widening the antenna and by stacking more than one TCFs together. The length and width ratio must be kept in mind when making change of the dimension of the antennas. In case of stacking the films, it should also be considered that, the transparency will reduce as more films are stacked together. So, a trade-off is to be made between the transparency of the film and the antenna efficiency when designing antennas using a transparent conducting material.

Among others, two advanced transparent conductive films, Nano-C Hybrid and AgNW are described herein. In particular, these films are described with respect to their application to the area of antenna design. These transparent films can conduct electrically while retaining the transparency characteristics. TCFs can loose some of their core attributes over time. This kind of transformation is not swift, but is noticeable when put under test. Antennas made from new Nano-C Hybrid and AgNW samples work better than those made from older samples. The transparency and performance of the antennas also depend on the sheet resistance R_{S} of the corresponding TCF. Higher sheet resistance yields higher transparency but lower antenna performance. Accordingly, there is a trade-off between sheet resistance, film thickness, transparency, and antenna efficiency when choosing the best antenna design element.

Power handling capability is different for Nano-C Hybrid and AgNW. Nano-C Hybrid can handle higher amount of DC, AC, and RF power than AgNW. The advantage AgNW has over Nano-C Hybrid is that they do not endure deformation when pushed to the highest limit. This can be an influential factor in deciding which material should be used for constructing antennas for specific applications. Apart from this phenomenon of deformity, Nano-C Hybrid outperforms AgNW in all the aspects of being a good conductive material. This means, combining CNT and AgNW helps create better transparent conductors.

The impedance of a TCF is a function of its sheet resistance, R_{S} and the respective length (L) and width (W). In order to create a rectangular monopole antenna using TCFs, the length should be slightly higher than the width. A good width-to-length (W-to-L) ratio is found to be 0.8 and this should be kept in mind while designing a monopole antenna using a transparent conductive film. The resistance of the Nano-C Hybrid and AgNW films does not tend to rise dramatically with higher frequency which means these TCFs can be used to produce working S-band or X-band antennas.

Simulation results suggest, there are two effective ways to enhance the gain of a transparent antenna. If the width of the antenna is increased, the gain increases. Secondly, if two or more films are stacked together to make an antenna, the gain becomes higher than the gain of a single-sample antenna. It should be noted that, stacking the films will reduce the transparency; so, a trade-off between the transparency and the antenna efficiency has to be made. Experimental data corroborates this assumption as it is seen that, if the width of a Nano-C Hybrid or AgNW based monopole antenna is doubled, the gain is increased by at least 0.6 dB. On the other hand, the gain enhances by at least 0.7 dB when two samples having the example optimum width-to-length ratio (e.g., 0.8) are stacked together instead of one. This is evidence that, widening and stacking can definitely be two practical methods of gain enhancement of a transparent antenna.

Although much of this testing was performed using monopole antennas, the results of the testing, including results for film geometry optimization and film staking are applicable to other types of antennas including, for example, dipole antennas.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results. As one example, the processes depicted in the accompanying figures do not necessarily require the particular order shown, or sequential order, to achieve desirable results. In some cases, multitasking and parallel performance or processing may be advantageous.

What is claimed is:

1. An optically transparent antenna, the antenna comprising:
a substrate layer; and
a first conductive layer formed on the substrate layer, wherein (i) a length of the conductive layer is greater than a width of the first conductive layer and (ii) the width of the first conductive layer is at least one eighth the length of the conductive layer,
wherein the first conductive layer is optically transparent such that the first conductive layer exhibits optical transmission of approximately 80% or more.

2. The antenna of claim 1, wherein the first conductive layer exhibits optical transmission of at least 90%.

3. The antenna of claim 1, wherein a ratio of the width of the first conductive layer to the length of the first conductive layer is between 0.5 and 0.9.

4. The antenna of claim 3, wherein the ratio of the width of the first conductive layer to the length of the conductive layer is or substantially is 0.8.

5. The antenna of claim 1, wherein the first conductive layer is a layer of one of the following materials: silver-nanowire (AgNW), carbon nanotube (CNT), a hybrid material that combines carbon nanotube and silver-nanowire (AgNW), graphene, indium tin oxide (ITO), gallium-doped zinc oxide (GZO), aluminum-doped zinc oxide (AZO), a Copper-silver-nanowire (AgNW) hybrid or network material, or a Aluminum-doped Zinc Oxide (AZO)-silver-nanowire (AGNW)-Aluminum-doped Zinc Oxide (AZO) hybrid or network material.

6. The antenna of claim 1, comprising a second conductive layer arranged below the conductive layer such that the conductive layer and the second conductive layer overlap, wherein (i) a length of the second conductive layer is greater than a width of the second conductive layer and (ii) the width of the second conductive layer is at least one eighth the length of the second conductive layer,
wherein the second conductive layer is optically transparent such that the second conductive layer exhibits optical transmission of approximately 80% or more.

7. The antenna of claim 6, wherein:
a length of the second conductive layer is the same or substantially the same as the length of the first conductive layer;
a width of the second conductive layer is the same or substantially the same as the width of the first conductive layer;
a top surface of the first conductive layer is located in a first plane; and
a top surface of the second conductive layer is located in a second plane parallel or substantially parallel to the first plane.

8. The antenna of claim 6, wherein a thickness of the second conductive layer is the same or is substantially the same as a thickness of the first conductive layer.

9. The antenna of claim 6, wherein the first conductive layer and the second conductive layer each exhibit an optical transmission of at least 90%.

10. The antenna of claim 6, wherein:
a thickness of the first conductive layer is less than 100 nm; and
a thickness of the second conductive layer is less than 100 nm.

11. The antenna of claim 6, wherein:
a ratio of the width of the first conductive layer to the length of the first conductive layer is between 0.5 and 0.9; and
a ratio of the width of the second conductive layer to the length of the second conductive layer is between 0.5 and 0.9.

12. The antenna of claim 11, wherein:
the ratio of the width of the first conductive layer to the length of the first conductive layer is or substantially is 0.8; and
the ratio of the width of the second conductive layer to the length of the second conductive layer is or substantially is 0.8.

13. The antenna of claim 6, wherein:
the first conductive layer is electrically connected to a device capable of introducing a current in the conductive layer; and
the first conductive layer and the second conductive layer are arranged sufficiently close to one another such that, when current is introduced by the device in the first conductive layer, approximately the same level of current is introduced in the second conductive layer by electrical coupling between the first conductive layer and the second conductive layer.

14. The antenna of claim 13, wherein the antenna is configured such that the second conductive layer is dependent on current being introduced in the first conductive layer by the device for current to be introduced in the second conductive layer.

15. The antenna of claim 6, wherein:
the first conductive layer is electrically connected to a device;
the second conductive layer is electrically connected to the device; and
the device is capable of introducing a current in the first conductive layer and the second conductive layer.

16. The antenna of claim 7, comprising a third conductive layer arranged below the first conductive layer and the second conductive layer, wherein (i) a length of the third conductive layer is greater than a width of the third conductive layer and (ii) the width of the third conductive layer is at least one eighth the length of the third conductive layer;
wherein a length of the third conductive layer is the same or substantially the same as the length of the first conductive layer and the second conductive layer;
wherein a width of the third conductive layer is the same or substantially the same as the width of the first conductive layer and the second conductive layer;
wherein a top surface of the third conductive layer is located in a third plane parallel or substantially parallel to the first plane and the second plane; and
wherein the third conductive layer is optically transparent.

17. The antenna of claim 7, wherein the first conductive layer and the second conductive layer fully overlap.

18. The antenna of claim 1, wherein the antenna is a dipole antenna.

19. A method for fabricating an optically transparent antenna, the method comprising:
depositing a first film of an optically transparent material on a first side of a first substrate such that the length of the first film is greater than a width of the first film;
depositing a second film of material on a first side of a second substrate that the length of the second film is greater than a width of the second film;
joining a bottom surface of the first substrate to a top surface of the second film such that (i) the second film is placed below the first film and (ii) the first film and the second film overlap; and
electrically coupling the first film to a transmitter, receiver, or transceiver.

20. A method for fabricating an optically transparent antenna, the method comprising:
depositing a first film of an optically transparent material on a first side of a first substrate such that the length of the first film is greater than a width of the first film;
depositing a second film of material on a second side of the first substrate such that (i) the length of the second film is greater than a width of the second film, (ii) the second film is placed below the first film, and (iii) the first film and the second film overlap; and
electrically coupling at least one of the first film and the second film to a transmitter, receiver, or transceiver.
